(19) United States
(12) Patent Application Publication
(10) Pub. No.: US 2023/0213899 A1
(43) Pub. Date: Jul. 6, 2023

(54) MOBILE SENSING FOR BEHAVIOR MONITORING

(71) Applicant: SparkCognition, Inc., Austin, TX (US)

(72) Inventor: Syed Mohammad Amir Husain, Georgetown, TX (US)

(21) Appl. No.: 18/149,534

(22) Filed: Jan. 3, 2023

Related U.S. Application Data
(60) Provisional application No. 63/266,373, filed on Jan. 4, 2022.

(51) Int. Cl. G05B 13/04; G05B 13/02

(52) U.S. Cl. CPC G05B 13/042; G05B 13/0265; G05D 1/101

(57) ABSTRACT

A method of behavior monitoring includes receiving, from a first sensor of a mobile sensor platform, first sensor data indicative of operation of a monitored device, wherein the monitored device is distinct from the mobile sensor platform; providing, as input to a trained behavior model associated with the monitored device, input data based at least in part on the first sensor data to generate behavior model output data; generating, based on the behavior model output data, a control command; and sending the control command to the mobile sensor platform or the monitored device.

### FIELD

The present disclosure is generally related to using trained models in association with behavior modeling of monitored devices with a mobile sensor platform.

### BACKGROUND

Abnormal behavior can be detected using rules established by a subject matter expert or derived from physics-based models. However, it can be expensive and time-consuming to properly establish and confirm such rules. The time and expense involved is compounded if the equipment or process being monitored has several normal operational states or if what behavior is considered normal changes from time to time. To illustrate, as equipment operates, the normal behavior of the equipment may change due to wear. It can be challenging to establish rules to monitor this type of gradual change in normal behavior. Further, in such situations, the equipment may occasionally undergo maintenance to offset the effects of the wear. Such maintenance can result in a sudden change in normal behavior, which is also challenging to monitor using established rules.

These problems are compounded when the equipment itself is incapable of or ineffective at self-monitoring and/or self-reporting. Legacy equipment remains incapacitated by the combination of increasing maintenance and ineffective data monitoring capabilities. Legacy equipment monitoring is even more difficult in remote or dangerous operational areas as well as areas containing many different types of legacy equipment.

### SUMMARY

The present disclosure describes systems and methods that enable use of trained models to detect anomalous behavior of monitored devices, systems, or processes. Such monitored devices, systems, or processes are collectively referred to herein as “devices” for ease of reference. In some implementations, the models can be automatically generated and trained based on historic data. Additionally, the present disclosure describes systems and methods that enable the incorporation of un-sensored or under-sensored equipment, regardless of location or device diversity, into a monitoring environment that can take full advantage of the trained models.

In some aspects, a method of behavior monitoring includes receiving, from a first sensor of a mobile sensor platform, first sensor data indicative of operation of a monitored device, wherein the monitored device is distinct from the mobile sensor platform; providing, as input to a trained behavior model associated with the monitored device, input data based at least in part on the first sensor data to generate behavior model output data; generating, based on the behavior model output data, a control command; and sending the control command to the mobile sensor platform or the monitored device.

In some aspects, a system for behavior monitoring includes one or more processors configured to receive, from a first sensor of a mobile sensor platform, first sensor data indicative of operation of a monitored device, wherein the monitored device is distinct from the mobile sensor platform; provide, as input to a trained behavior model associated with the monitored device, input data based at least in part on the first sensor data to generate behavior model output data; generate, based on the behavior model output data, a control command; and send the control command to the mobile sensor platform or the monitored device.

In some aspects, a computer-readable storage device stores instructions. The instructions, when executed by one or more processors, cause the one or more processors to receive, from a first sensor of a mobile sensor platform, first sensor data indicative of operation of a monitored device, wherein the monitored device is distinct from the mobile sensor platform; provide, as input to a trained behavior model associated with the monitored device, input data based at least in part on the first sensor data to generate behavior model output data; generate, based on the behavior model output data, a control command; and send the control command to the mobile sensor platform or the monitored device.

### BRIEF DESCRIPTION OF THE DRAWINGS

FIG. 1 depicts a system for behavior modeling for one or more monitored devices using a mobile sensor platform in accordance with some examples of the present disclosure.

FIG. 2 depicts a system for behavior monitoring of one or more monitored devices using a mobile sensor platform in accordance with some examples of the present disclosure.

FIG. 3 depicts a block diagram of a particular implementation of components that may be included in any of the systems of FIGS. 1-2 in accordance with some examples of the present disclosure.

FIG. 4 is a flow chart of an example of a method for behavior modeling for monitored devices using a mobile sensor platform, in accordance with some examples of the present disclosure.

FIG. 5 illustrates an example of a computer system corresponding to one or more of the systems of FIGS. 1-3 in accordance with some examples of the present disclosure.

### DETAILED DESCRIPTION

Systems and methods are described that enable use of trained models to detect anomalous behavior of devices. For example, the anomalous behavior may be indicative of an impending failure of the asset, and the systems and methods disclose herein may facilitate identification of the impending failure so that maintenance or other actions can be taken.

In an illustrative implementation, a mobile sensor platform including multiple sensors can be configured to deploy one or more of those sensors to monitor an un-sensored or under-sensored device. For the purposes of the present disclosure, a “mobile” sensor platform includes a sensor platform configured to monitor an un-sensored or under-sensored device, where the sensor platform is distinct from the un(der)-sensored device, and the sensor platform provides at least a portion of its own locomotive power. For the purposes of the present disclosure, an “un-sensored or under-sensored” device includes any device for which particular sensored data is unavailable from the device itself. For example, an un-sensored or under-sensored device can include a device with no local sensors; a device with certain types of sensors but not sensors capable of gathering the particular data to be used with the one or more trained models (e.g., a wind turbine with humidity sensors but not acoustic sensors); a sensored device where one or more of the device's sensors are malfunctioning, inoperable, or otherwise currently incapable of gathering the particular data; or some combination thereof. An un-sensored or under-sensored device, as used in the present disclosure, can also include a portion or component of a device, where only the portion or component qualifies as un-sensored or under-sensored device. Also for the purposes of the present disclosure, a mobile sensor platform “distinct” from a monitored device includes a mobile sensor platform that is able to be wholly physically separated from the monitored device while maintaining the ordinary operating capabilities of the monitored device.

In an illustrative implementation, the mobile sensor platform can be further configured to communicate sensor data indicative of operation of the monitored device to a computing device configured to provide input data based at least in part on that sensor data as input to a trained behavior model associated with the monitored device. The computing device can be further configured to generate, based on the behavior model output data, a control command and send that control command to the mobile sensor platform and/or the monitored device. The behavior model can be used for, among other purposes, determining anomalous behavior associated with the monitored device.

For example, an autonomous vehicle, unmanned aerial vehicle, or other robotic device equipped with a number of sensors (e.g., acoustic sensor(s), optical sensor(s), infrared sensor(s), vibration sensor(s), tachometer(s), etc.) can act as a mobile sensor platform, deployed to monitor an un-sensored or under-sensored device such as an oil rig, wind turbine, etc. The sensor data from the mobile sensor platform can then be used to generate an input to one or more trained behavior models associated with the monitored device. Based on the output data from the one or more trained behavior models, a control command for the mobile sensor platform or the monitored device can be generated. For example, the output data from a trained behavior model may indicate that the monitored device is operating in an anomalous condition. A corresponding control command can be sent to the mobile sensor platform or the monitored device to take corrective action associated with a fix for the anomalous condition.

In certain anomaly detection implementations, multiple anomaly detection models can be generated and scored relative to one another to select an anomaly detection model to be deployed. Factors used to generate a score for each anomaly detection model and a scoring mechanism used to generate the score can be selected based on data that is to be used to monitor the asset (e.g., the nature or type of sensor data to be used), based on particular goals to be achieved by monitoring (e.g., whether early prediction or a low false positive rate is to be preferred), or based on both.

The described systems and methods address a significant challenge in deploying trained behavior models in un-sensored or under-sensored environments. As a result, the described systems and methods can provide cost-beneficial monitoring of un-sensored or under-sensored devices that may not be identical, are spread out over large physical distances (e.g., a wind farm including a plurality of wind turbines), are located in hazardous environmental conditions (e.g., a deep-sea oil rig), etc.

Particular aspects of the present disclosure are described below with reference to the drawings. In the description, common features are designated by common reference numbers throughout the drawings. As used herein, various terminology is used for the purpose of describing particular implementations only and is not intended to be limiting. For example, the singular forms “a,” “an,” and “the” are intended to include the plural forms as well, unless the context clearly indicates otherwise. Further the terms “comprise,” “comprises,” and “comprising” may be used interchangeably with “include,” “includes,” or “including.” Additionally, the term “wherein” may be used interchangeably with “where.” As used herein, “exemplary” may indicate an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to a grouping of one or more elements, and the term “plurality” refers to multiple elements.

In the present disclosure, terms such as “determining,” “calculating,” “estimating,” “shifting,” “adjusting,” etc. may be used to describe how one or more operations are performed. Such terms are not to be construed as limiting and other techniques may be utilized to perform similar operations. Additionally, as referred to herein, “generating,” “calculating,” “estimating,” “using,” “selecting,” “accessing,” and “determining” may be used interchangeably. For example, “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive electrical signals (digital signals or analog signals) directly or indirectly, such as via one or more wires, buses, networks, etc. As used herein, “directly coupled” may include two devices that are coupled (e.g., communicatively coupled, electrically coupled, or physically coupled) without intervening components.

As used herein, the term “machine learning” should be understood to have any of its usual and customary meanings within the fields of computers science and data science, such meanings including, for example, processes or techniques by which one or more computers can learn to perform some operation or function without being explicitly programmed to do so. As a typical example, machine learning can be used to enable one or more computers to analyze data to identify patterns in data and generate a result based on the analysis. For certain types of machine learning, the results that are generated include data that indicates an underlying structure or pattern of the data itself. Such techniques, for example, include so called “clustering” techniques, which identify clusters (e.g., groupings of data elements of the data).

For certain types of machine learning, the results that are generated include a data model (also referred to as a “machine-learning model” or simply a “model”). Typically, a model is generated using a first data set to facilitate analysis of a second data set. For example, a first portion of a large body of data may be used to generate a model that can be used to analyze the remaining portion of the large body of data. As another example, a set of historical data can be used to generate a model that can be used to analyze future data.

Since a model can be used to evaluate a set of data that is distinct from the data used to generate the model, the model can be viewed as a type of software (e.g., instructions, parameters, or both) that is automatically generated by the computer(s) during the machine learning process. As such, the model can be portable (e.g., can be generated at a first computer, and subsequently moved to a second computer for further training, for use, or both). Additionally, a model can be used in combination with one or more other models to perform a desired analysis. To illustrate, first data can be provided as input to a first model to generate first model output data, which can be provided (alone, with the first data, or with other data) as input to a second model to generate second model output data indicating a result of a desired analysis. Depending on the analysis and data involved, different combinations of models may be used to generate such results. In some examples, multiple models may provide model output that is input to a single model. In some examples, a single model provides model output to multiple models as input.

Examples of machine-learning models include, without limitation, perceptrons, neural networks, support vector machines, regression models, decision trees, Bayesian models, Boltzmann machines, adaptive neuro-fuzzy inference systems, as well as combinations, ensembles and variants of these and other types of models. Variants of neural networks include, for example and without limitation, prototypical networks, autoencoders, transformers, self-attention networks, convolutional neural networks, deep neural networks, deep belief networks, etc. Variants of decision trees include, for example and without limitation, random forests, boosted decision trees, etc.

Since machine-learning models are generated by computer(s) based on input data, machine-learning models can be discussed in terms of at least two distinct time windows—a creation/training phase and a runtime phase. During the creation/training phase, a model is created, trained, adapted, validated, or otherwise configured by the computer based on the input data (which in the creation/training phase, is generally referred to as “training data”). Note that the trained model corresponds to software that has been generated and/or refined during the creation/training phase to perform particular operations, such as classification, prediction, encoding, or other data analysis or data synthesis operations. During the runtime phase (or “inference” phase), the model is used to analyze input data to generate model output. The content of the model output depends on the type of model. For example, a model can be trained to perform classification tasks or regression tasks, as non-limiting examples. In some implementations, a model may be continuously, periodically, or occasionally updated, in which case training time and runtime may be interleaved or one version of the model can be used for inference while a copy is updated, after which the updated copy may be deployed for inference.

In some implementations, a previously generated model is trained (or re-trained) using a machine-learning technique. In this context, “training” refers to adapting the model or parameters of the model to a particular data set. Unless otherwise clear from the specific context, the term “training” as used herein includes “re-training” or refining a model for a specific data set. For example, training may include so called “transfer learning.” As described further below, in transfer learning a base model may be trained using a generic or typical data set, and the base model may be subsequently refined (e.g., re-trained or further trained) using a more specific data set.

A data set used during training is referred to as a “training data set” or simply “training data”. The data set may be labeled or unlabeled. “Labeled data” refers to data that has been assigned a categorical label indicating a group or category with which the data is associated, and “unlabeled data” refers to data that is not labeled. Typically, “supervised machine-learning processes” use labeled data to train a machine-learning model, and “unsupervised machine-learning processes” use unlabeled data to train a machine-learning model; however, it should be understood that a label associated with data is itself merely another data element that can be used in any appropriate machine-learning process. To illustrate, many clustering operations can operate using unlabeled data; however, such a clustering operation can use labeled data by ignoring labels assigned to data or by treating the labels the same as other data elements.

Machine-learning models can be initialized from scratch (e.g., by a user, such as a data scientist) or using a guided process (e.g., using a template or previously built model). Initializing the model includes specifying parameters and hyperparameters of the model. “Hyperparameters” are characteristics of a model that are not modified during training, and “parameters” of the model are characteristics of the model that are modified during training. The term “hyperparameters” may also be used to refer to parameters of the training process itself, such as a learning rate of the training process. In some examples, the hyperparameters of the model are specified based on the task the model is being created for, such as the type of data the model is to use, the goal of the model (e.g., classification, regression, anomaly detection), etc. The hyperparameters may also be specified based on other design goals associated with the model, such as a memory footprint limit, where and when the model is to be used, etc.

Model type and model architecture of a model illustrate a distinction between model generation and model training. The model type of a model, the model architecture of the model, or both, can be specified by a user or can be automatically determined by a computing device. However, neither the model type nor the model architecture of a particular model is changed during training of the particular model. Thus, the model type and model architecture are hyperparameters of the model and specifying the model type and model architecture is an aspect of model generation (rather than an aspect of model training). In this context, a “model type” refers to the specific type or sub-type of the machine-learning model. As noted above, examples of machine-learning model types include, without limitation, perceptrons, neural networks, support vector machines, regression models, decision trees, Bayesian models, Boltzmann machines, adaptive neuro-fuzzy inference systems, as well as combinations, ensembles and variants of these and other types of models. In this context, “model architecture” (or simply “architecture”) refers to the number and arrangement of model components, such as nodes or layers, of a model, and which model components provide data to or receive data from other model components. As a non-limiting example, the architecture of a neural network may be specified in terms of nodes and links. To illustrate, a neural network architecture may specify the number of nodes in an input layer of the neural network, the number of hidden layers of the neural network, the number of nodes in each hidden layer, the number of nodes of an output layer, and which nodes are connected to other nodes (e.g., to provide input or receive output). As another non-limiting example, the architecture of a neural network may be specified in terms of layers. To illustrate, the neural network architecture may specify the number and arrangement of specific types of functional layers, such as long-short-term memory (LSTM) layers, fully connected (FC) layers, convolution layers, etc. While the architecture of a neural network implicitly or explicitly describes links between nodes or layers, the architecture does not specify link weights. Rather, link weights are parameters of a model (rather than hyperparameters of the model) and are modified during training of the model.

In many implementations, a data scientist selects the model type before training begins. However, in some implementations, a user may specify one or more goals (e.g., classification or regression), and automated tools may select one or more model types that are compatible with the specified goal(s). In such implementations, more than one model type may be selected, and one or more models of each selected model type can be generated and trained. A best performing model (based on specified criteria) can be selected from among the models representing the various model types. Note that in this process, no particular model type is specified in advance by the user, yet the models are trained according to their respective model types. Thus, the model type of any particular model does not change during training.

Similarly, in some implementations, the model architecture is specified in advance (e.g., by a data scientist); whereas in other implementations, a process that both generates and trains a model is used. Generating (or generating and training) the model using one or more machine-learning techniques is referred to herein as “automated model building”. In one example of automated model building, an initial set of candidate models is selected or generated, and then one or more of the candidate models are trained and evaluated. In some implementations, after one or more rounds of changing hyperparameters and/or parameters of the candidate model(s), one or more of the candidate models may be selected for deployment (e.g., for use in a runtime phase).

Certain aspects of an automated model building process may be defined in advance (e.g., based on user settings, default values, or heuristic analysis of a training data set) and other aspects of the automated model building process may be determined using a randomized process. For example, the architectures of one or more models of the initial set of models can be determined randomly within predefined limits. As another example, a termination condition may be specified by the user or based on configurations settings. The termination condition indicates when the automated model building process should stop. To illustrate, a termination condition may indicate a maximum number of iterations of the automated model building process, in which case the automated model building process stops when an iteration counter reaches a specified value. As another illustrative example, a termination condition may indicate that the automated model building process should stop when a reliability metric associated with a particular model satisfies a threshold. As yet another illustrative example, a termination condition may indicate that the automated model building process should stop if a metric that indicates improvement of one or more models over time (e.g., between iterations) satisfies a threshold. In some implementations, multiple termination conditions, such as an iteration count condition, a time limit condition, and a rate of improvement condition can be specified, and the automated model building process can stop when one or more of these conditions is satisfied.

Another example of training a previously generated model is transfer learning. “Transfer learning” refers to initializing a model for a particular data set using a model that was trained using a different data set. For example, a “general purpose” model can be trained to detect anomalies in vibration data associated with a variety of types of rotary equipment, and the general-purpose model can be used as the starting point to train a model for one or more specific types of rotary equipment, such as a first model for generators and a second model for pumps. As another example, a general-purpose natural-language processing model can be trained using a large selection of natural-language text in one or more target languages. In this example, the general-purpose natural-language processing model can be used as a starting point to train one or more models for specific natural-language processing tasks, such as translation between two languages, question answering, or classifying the subject matter of documents. Often, transfer learning can converge to a useful model more quickly than building and training the model from scratch.

Training a model based on a training data set generally involves changing parameters of the model with a goal of causing the output of the model to have particular characteristics based on data input to the model. To distinguish from model generation operations, model training may be referred to herein as optimization or optimization training. In this context, “optimization” refers to improving a metric, and does not mean finding an ideal (e.g., global maximum or global minimum) value of the metric. Examples of optimization trainers include, without limitation, backpropagation trainers, derivative free optimizers (DFOs), and extreme learning machines (ELMs). As one example of training a model, during supervised training of a neural network, an input data sample is associated with a label. When the input data sample is provided to the model, the model generates output data, which is compared to the label associated with the input data sample to generate an error value. Parameters of the model are modified in an attempt to reduce (e.g., optimize) the error value. As another example of training a model, during unsupervised training of an autoencoder, a data sample is provided as input to the autoencoder, and the autoencoder reduces the dimensionality of the data sample (which is a lossy operation) and attempts to reconstruct the data sample as output data. In this example, the output data is compared to the input data sample to generate a reconstruction loss, and parameters of the autoencoder are modified in an attempt to reduce (e.g., optimize) the reconstruction loss.

As another example, to use supervised training to train a model to perform a classification task, each data element of a training data set may be labeled to indicate a category or categories to which the data element belongs. In this example, during the creation/training phase, data elements are input to the model being trained, and the model generates output indicating categories to which the model assigns the data elements. The category labels associated with the data elements are compared to the categories assigned by the model. The computer modifies the model until the model accurately and reliably (e.g., within some specified criteria) assigns the correct labels to the data elements. In this example, the model can subsequently be used (in a runtime phase) to receive unknown (e.g., unlabeled) data elements, and assign labels to the unknown data elements. In an unsupervised training scenario, the labels may be omitted. During the creation/training phase, model parameters may be tuned by the training algorithm in use such that during the runtime phase, the model is configured to determine which of multiple unlabeled “clusters” an input data sample is most likely to belong to.

As another example, to train a model to perform a regression task, during the creation/training phase, one or more data elements of the training data are input to the model being trained, and the model generates output indicating a predicted value of one or more other data elements of the training data. The predicted values of the training data are compared to corresponding actual values of the training data, and the computer modifies the model until the model accurately and reliably (e.g., within some specified criteria) predicts values of the training data. In this example, the model can subsequently be used (in a runtime phase) to receive data elements and predict values that have not been received. To illustrate, the model can analyze time series data, in which case, the model can predict one or more future values of the time series based on one or more prior values of the time series.

In some aspects, the output of a model can be subjected to further analysis operations to generate a desired result. To illustrate, in response to particular input data, a classification model (e.g., a model trained to perform classification tasks) may generate output including an array of classification scores, such as one score per classification category that the model is trained to assign. Each score is indicative of a likelihood (based on the model's analysis) that the particular input data should be assigned to the respective category. In this illustrative example, the output of the model may be subjected to a softmax operation to convert the output to a probability distribution indicating, for each category label, a probability that the input data should be assigned the corresponding label. In some implementations, the probability distribution may be further processed to generate a one-hot encoded array. In other examples, other operations that retain one or more category labels and a likelihood value associated with each of the one or more category labels can be used.

One example of a machine-learning model is an autoencoder. An autoencoder is a particular type of neural network that is trained to receive multivariate input data, to process at least a subset of the multivariate input data via one or more hidden layers, and to perform operations to reconstruct the multivariate input data using output of the hidden layers. If at least one hidden layer of an autoencoder includes fewer nodes than the input layer of the autoencoder, the autoencoder may be referred to herein as a dimensional reduction model. If each of the one or more hidden layer(s) of the autoencoder includes more nodes than the input layer of the autoencoder, the autoencoder may be referred to herein as a denoising model or a sparse model, as explained further below.

For dimensional reduction type autoencoders, the hidden layer with the fewest nodes is referred to as the latent space layer. Thus, a dimensional reduction autoencoder is trained to receive multivariate input data, to perform operations to dimensionally reduce the multivariate input data to generate latent space data in the latent space layer, and to perform operations to reconstruct the multivariate input data using the latent space data. “Dimensional reduction” in this context refers to representing n values of multivariate input data using z values (e.g., as latent space data), where n and z are integers and z is less than n. Often, in an autoencoder the z values of the latent space data are then dimensionally expanded to generate n values of output data. In some special cases, a dimensional reduction model may generate m values of output data, where m is an integer that is not equal to n. As used herein, such special cases are still referred to as autoencoders as long as the data values represented by the input data are a subset of the data values represented by the output data or the data values represented by the output data are a subset of the data values represented by the input data. For example, if the multivariate input data includes 10 sensor data values from 10 sensors, and the dimensional reduction model is trained to generate output data representing only 5 sensor data values corresponding to 5 of the 10 sensors, then the dimensional reduction model is referred to herein as an autoencoder. As another example, if the multivariate input data includes 10 sensor data values from 10 sensors, and the dimensional reduction model is trained to generate output data representing 10 sensor data values corresponding to the 10 sensors and to generate a variance value (or other statistical metric) for each of the sensor data values, then the dimensional reduction model is also referred to herein as an autoencoder (e.g., a variational autoencoder).

Denoising autoencoders and sparse autoencoders do not include a latent space layer to force changes in the input data. An autoencoder without a latent space layer could simply pass the input data, unchanged, to the output nodes resulting in a model with little utility. Denoising autoencoders avoid this result by zeroing out a subset of values of an input data set while training the denoising autoencoder to reproduce the entire input data set at the output nodes. Put another way, the denoising autoencoder is trained to reproduce an entire input data sample based on input data that includes less than the entire input data sample. For example, during training of a denoising autoencoder that includes 10 nodes in the input layer and 10 nodes in the output layer, a single set of input data values includes 10 data values; however, only a subset of the 10 data values (e.g., between 2 and 9 data values) are provided to the input layer. The remaining data values are zeroed out. To illustrate, out of ten data values, seven data values may be provided to a respective seven nodes of the input layer, and zero values may be provided to the other three nodes of the input layer. Fitness of the denoising autoencoder is evaluated based on how well the output layer reproduces all ten data values of the set of input data values, and during training, parameters of the denoising autoencoder are modified over multiple iterations to improve its fitness.

Sparse autoencoders prevent passing the input data unchanged to the output nodes by selectively activating a subset of nodes of one or more of the hidden layers of the sparse autoencoder. For example, if a particular hidden layer has ten nodes, only three nodes may be activated for particular data. The sparse autoencoder is trained such that which nodes are activated is data dependent. For example, for a first data sample, three nodes of the particular hidden layer may be activated, whereas for a second data sample, five nodes of the particular hidden layer may be activated.

One use case for autoencoders is detecting significant changes in data. For example, an autoencoder can be trained using training sensor data gathered while a monitored system is operating in a first operational mode. In this example, after the autoencoder is trained, real-time sensor data from the monitored system can be provided as input data to the autoencoder. If the real-time sensor data is sufficiently similar to the training sensor data, then the output of the autoencoder should be similar to the input data. Illustrated mathematically:

[symbol]

−xₖ≈0

where [symbol] represents an output data value k and xₖ represents the input data value k. If the output of the autoencoder exactly reproduces the input, then [symbol] −xₖ=0 for each data value k. However, it is generally the case that the output of a well-trained autoencoder is not identical to the input. In such cases, [symbol] −xₖ=rₖ, where rₖ represents a residual value. Residual values that result when particular input data is provided to the autoencoder can be used to determine whether the input data is similar to training data used to train the autoencoder. For example, when the input data is similar to the training data, relatively small residual values should result. In contrast, when the input data is not similar to the training data, relatively large residual values should result. During runtime operation, residual values calculated based on output of the autoencoder can be used to determine the likelihood or risk that the input data differs significantly from the training data.

As one particular example, the input data can include multivariate sensor data representing operation of a monitored system. In this example, the autoencoder can be trained using training data gathered while the monitored system was operating in a first operational mode (e.g., a normal mode or some other mode). During use, real-time sensor data from the monitored system can be input to the autoencoder, and residual values can be determined based on differences between the real-time sensor data and output data from the autoencoder. If the monitored system transitions to a second operational mode (e.g., an abnormal mode, a second normal mode, or some other mode) statistical properties of the residual values (e.g., the mean or variance of the residual values over time) will change. Detection of such changes in the residual values can provide an early indication of changes associated with the monitored system. To illustrate, one use of the example above is early detection of abnormal operation of the monitored system. In this use case, the training data includes a variety of data samples representing one or more “normal” operating modes. During runtime, the input data to the autoencoder represents the current (e.g., real-time) sensor data values, and the residual values generated during runtime are used to detect early onset of an abnormal operating mode. In other use cases, autoencoders can be trained to detect changes between two or more different normal operating modes (in addition to, or instead of, detecting onset of abnormal operating modes).

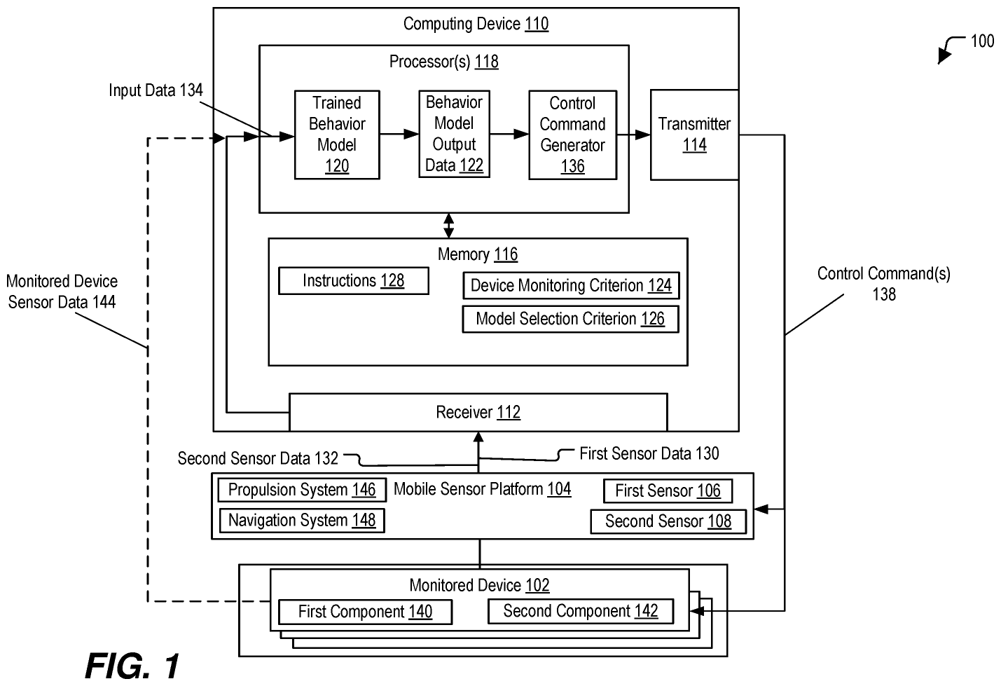

FIG. 1 depicts a system 100 for behavior modeling for one or more monitored devices 102 using a mobile sensor platform 104 in accordance with some examples of the present disclosure. The system 100 includes one or more sensors coupled to the mobile sensor platform. For example, the mobile sensor platform 104 can include a first sensor 106 and a second sensor 108. The mobile sensor platform 104 can be configured to deploy the first sensor 106 and/or the second sensor 108 to monitor one or more monitored devices 102. In some implementations, the mobile sensor platform 104 can be configured to receive the first sensor data 130 and/or the second sensor data 132 via a direct communication interface between the monitored device 102 and the mobile sensor platform 104. In the same or alternative implementations, the mobile sensor platform 104 can be configured to receive the first sensor data 130 and/or the second sensor data 132 via one or more direct and/or indirect communication paths, including a wired and/or wireless communication connection.

In this context, a “monitored device” refers to one or more devices, one or more systems, or one or more processes that are monitored to detect abnormal behavior. To illustrate, the monitored device 102 can include one or more mechanical devices, one or more electromechanical devices, one or more electrical devices, one or more electronic devices, or various combinations thereof.

Additionally in this context, a “mobile sensor platform” refers to one or more devices, one or more systems, or one or more components designed to monitor one or more monitored devices 102, while being distinct from the monitored devices 102. To illustrate, the mobile sensor platform 104 can include an autonomous or semi-autonomous vehicle that includes a propulsion system 146 and a navigation system 148; an unmanned aerial vehicle; an unmanned terrestrial rover-type vehicle; an unmanned submersible vehicle, etc. configured to monitor one or more monitored devices 102.

In some implementations, the mobile sensor platform 104 can be configured to monitor a plurality of monitored devices 102. For example, the mobile sensor platform 104 can be configured to monitor several wind turbines on a remote wind farm, multiple deep-sea oil rigs, etc. In a particular aspect, the mobile sensor platform 104 can be configured to automatically select for monitoring a particular monitored device 102 from among the plurality of monitored devices based on one or more device monitoring criteria 124. Device monitoring criteria 124 can include any appropriate data used in determining which of a plurality of monitored devices 102 should be monitored by the mobile sensor platform 104.

For example, the device monitoring criteria 124 can include one or more temporal criteria. The temporal criteria can be, for example, associated with a particular time of day, a particular day of the week or year, a particular period associated with an operational schedule or a maintenance schedule for the monitored device 102, a particular sensing time period etc. To illustrate, a mobile sensor platform 104 can select a particular monitored device 102 for monitoring first thing in the morning, every Tuesday, during a particular part of an operational cycle of the particular monitored device 102, an amount of time for one or more sensors to be operational, or some combination thereof.

In another example, the device monitoring criteria 124 can include one or more sensor data criteria. The sensor data criteria can, for example, identify a measurement made by one or more sensors of the mobile sensor platform 104, including when the measurement is a measurement of a second monitored device 102. To illustrate, a mobile sensor platform 104 can include certain sensors (e.g., one or more acoustic sensors) whose sensor readings include sensor readings from a second monitored device that the mobile sensor platform 104 is not actively monitoring. For example, a mobile sensor platform 104 can be configured to receive sensor data indicative of an anomalous noise at a second monitored device 102 while the mobile sensor platform is actively monitoring a first monitored device 102. In this circumstance, the mobile sensor platform can be configured to select the second monitored device 102 for active monitoring.

In some implementations, the mobile sensor platform is coupled to a computing device 110. The computing device 110 can include a receiver 112, a transmitter 114, and a memory 116 that are coupled to one or more processors 118. In various implementations, the computing device 110 is configured to use one or more trained behavior models 120 to generate, based on the behavior model output data 122, one or more control commands 138 for communication, via the transmitter 114, to the monitored device 102 or the mobile sensor platform 104, as described further below.

In some implementations, the memory 116 includes volatile memory devices, non-volatile memory devices, or both, such as one or more hard drives, solid-state storage devices (e.g., flash memory, magnetic memory, or phase change memory), a random access memory (RAM), a read-only memory (ROM), one or more other types of storage devices, or any combination thereof. The memory 116 stores data (e.g., one or more device monitoring criteria 124, one or more model selection criteria 126, etc.) and instructions 128 (e.g., computer code) that are executable by the one or more processors 118. For example, the instructions 128 can include one or more trained behavior models 120 (e.g., trained machine learning models) that are executable by the one or more processors 118 to initiate, perform, or control the various operations described with reference to FIG. 1. For example, the one or more trained behavior models 120 can include an anomaly detection model, an alert generation model, or both.

In some implementations, the processor(s) 118 can be configured to select a trained behavior model 120 from among a plurality of trained behavior models. In a particular aspect, each of the plurality of trained behavior models can be associated with a particular type or mode of operational analysis (e.g., anomaly detection, alert generation, etc.). In the same or another particular aspect, each of the plurality of trained behavior models can be associated with one or more of a plurality of monitored devices 102.

In some implementations, the selection of the trained behavior model 120 can be based on one or more model selection criteria 126. The model selection criteria 126 can be any appropriate data associated with selecting a trained behavior model 120 from among a plurality of trained behavior models.

In a particular aspect, the model selection criteria can include data associated with a location of the mobile sensor platform 104. For example, the physical location of the mobile sensor platform 104 can indicate which monitored device 102 from among a plurality of monitored devices the mobile sensor platform 104 is currently monitoring. This information can be used to select the appropriate trained behavior model 120 associated with the particular monitored device 102. In the same or another particular aspect, the model selection criteria 126 can include data associated with a device type of the monitored device 102. For example, a monitored wind turbine may have a different trained behavior model 120 than a monitored oil well. In the same or another particular aspect, the model selection criteria 126 can include data associated with a history of the monitored device 102. For example, if a particular monitored device 102 has a failure history or a maintenance history, a different trained behavior model 120 can be selected than what would be selected for a monitored device 102 without such a history. To illustrate, a first trained behavior model 120 may be used to monitor a wind turbine that has recently undergone particular maintenance to replace a particular component and a second trained behavior model 120 may be used to monitor a second wind turbine in which the particular component has not been replaced.

The one or more processors 118 include one or more single-core or multi-core processing units, one or more digital signal processors (DSPs), one or more graphics processing units (GPUs), or any combination thereof. The one or more processors 118 are configured to receive, via the receiver 112, a portion of the first sensor data 130 during a sensing period and/or a portion of the second sensor data 132 during the sensing period. In some implementations, the one or more processors 118 are configured to process the portion of the first sensor data 130 and/or the portion of the second sensor data 132 to generate the input data 134 for the one or more trained behavior models 120 and to use the one or more trained behavior models 120 to generate, via a control command generator 136, one or more control commands 138 for communication to the mobile sensor platform 104 or the monitored device 102. The one or more processors 118 can also be configured to process the first sensor data 130 and/or the second sensor data 132 to determine whether to generate an alert.

In some implementations, the input data 134 can include a variety of data representative of certain operations associated with one or more monitored device(s) 102. For example, the input data 134 can include data representative of a sound generated by operation of the monitored device 102, an optical measurement of the monitored device 102, a vibration measurement of the monitored device 102, a rotation measurement of the monitored device 102, etc., or some combination thereof. As another example, the input data 134 can include data representative of one or more images associated with one or more components of the monitored device 102.

The receiver 112 is configured to receive the first sensor data 130 and/or the second sensor data 132 from the mobile sensor platform 104. In an example, the receiver 112 includes a bus interface, a wireline network interface, a wireless network interface, or one or more other interfaces or circuits configured to receive the first sensor data 130 and/or the second sensor data 132 via wireless transmission, via wireline transmission, or any combination thereof. In a particular aspect, the receiver 112 can be configured to receive the first and/or second sensor data 130, 132 via a direct communication interface between the monitored device 102 and the mobile sensor platform 104. In other particular aspects, the receiver 112 can be configured to receive the first and/or second sensor data 130, 132 via one or more direct and/or indirect communication paths, including wired and/or wireless communication connection. In some implementations, the mobile sensor platform 104 sends the first sensor data 130, the second sensor data 132, or both, to the computing device 110 in real time (e.g., while the mobile sensor platform 104 is still gathering data representing operation of the monitored device 102). In some implementations, the mobile sensor platform 104 gathers and stores the first sensor data 130, the second sensor data 132, or both, for later transmission to the computing device 110.

During operation, the first sensor 106 and the second sensor 108 generate signals based on measuring physical characteristics, electromagnetic characteristics, radiologic characteristics, and/or other measurable characteristics associated with the monitored device 102. The mobile sensor platform 104 generates the first sensor data 130 and the second sensor data 132 based on the signals from the first sensor 106 and the second sensor 108, respectively. In some implementations, the mobile sensor platform 104 samples and encodes (e.g., according to a communication protocol) the signals to generate the first sensor data 130 and the second sensor data 132. In some implementations, the mobile sensor platform 104 processes the signals from the first sensor 106 and the second sensor 108 to generate the first sensor data 130, the second sensor data 132, or both. For example, the mobile sensor platform 104 may calculate values of the first sensor data 130 using information from two or more sensors of the mobile sensor platform 104. To illustrate, the first sensor 106 may include an infrared image sensor, and the mobile sensor platform 104 may use infrared image data to calculate temperatures of portions of the monitored device 102 that are represented in the infrared image data. In this illustrative example, the first sensor data 130 may include the calculated temperatures. As another illustrative example, the first sensor 106 may generate time domain signals, and the mobile sensor platform 104 may generate the first sensor data 130 by sampling and windowing the time domain signals and transforming windowed samples of the signal to a frequency domain.

In some implementations, each sensor can generate a time series of measurements. The time series from a particular sensor is also referred to herein as a “feature” or as “feature data”. Different sensors can have different sample rates. The first sensor 106 and/or the second sensor 108 can generate sensor data samples periodically (e.g., with regularly spaced sampling periods). The first sensor 106 and/or the second sensor 108 can also, or alternatively, generate sensor data samples occasionally (e.g., whenever a state change occurs).

In some implementations, the processor(s) 118 receive a portion of the first sensor data 130 and/or a portion of the second sensor data 132 for a particular timeframe. During some timeframes, the sensor data for a particular timeframe may include a single data sample for each feature. During some timeframes, the sensor data for the particular timeframe may include multiple data samples for one or more of the features. During some timeframes, the sensor data for the particular timeframe may include no data samples for one or more of the features. As one example, if the first sensor 106 registers state changes (e.g., on/off state changes), the second sensor 108 generates a data sample once per second, a third sensor generates ten data samples per second, and the processor(s) 118 process one second timeframes, then for a particular timeframe the processor(s) 118 can receive sensor data that includes no data samples from the first sensor 106 (e.g., if no state change occurred), one data sample from the second sensor 108, and ten samples from the third sensor. Other combinations of sampling rates and preprocessing timeframes are used in other examples.

In some implementations, the computing device 110 includes a preprocessor configured to generate the input data 134 for the one or more trained behavior models 120 based on the first sensor data 130 and/or the second sensor data 132. For example, the preprocessor can be configured to perform a batch normalization process on a portion of the first sensor data 130 and/or a portion of the second sensor data 132. As another example, the preprocessor may resample the first and/or second sensor data 130, 132, may filter the first and/or second sensor data 130, 132, may impute data, may use the sensor data (and possibly other data) to generate new feature data values, may perform other preprocessing operations, or a combination thereof. In a particular aspect, the specific preprocessing operations that a preprocessor performs can be determined based on the training of the one or more trained behavior models 120. For example, an anomaly detection model can be trained to accept as input a specific set of features, and the preprocessor can be configured to generate, based on the first and/or second sensor data 130, 132, input data for the anomaly detection model including a specific set of features.

In a particular aspect, one or more of the trained behavior models 120 (e.g., one or more anomaly detection models) can be configured to generate an anomaly score for each data sample of the input data. One or more of the anomaly detection models can be configured to evaluate the anomaly score to determine whether to generate an alert. As one example, an alert generation model can compare one or more values of the anomaly score to one or more respective thresholds to determine whether to generate an alert. The respective threshold(s) may be preconfigured or determined dynamically (e.g., based on one or more of the sensor data values, based on one or more of the input data values, or based on one or more of the anomaly score values). In a particular implementation, an alert generation model can be configured to determine whether to generate the alert using a sequential probability ratio test (SPRT) based on current anomaly score values and historical anomaly score values (e.g., based on historical sensor data).

Thus, the system 100 can be configured to enable detection of deviation from an operating state of the monitored device 102, such as detecting a transition from a first operating state (e.g., a “normal” state to which the model is trained) to a second operating state (e.g., an “abnormal” state). In some implementations, the second operating state, although distinct from the first operating state, may also be a “normal” operating state that is not associated with a malfunction or fault of the asset.

Although certain illustrative examples are provided above for the trained behavior model(s) 120, other types of trained behavior model(s) 120 can be used without departing from the scope of the present disclosure. For example, the trained behavior model 120 can include a dimensional-reduction model such as an autoencoder, a residual generator, an operation state classifier, or other appropriate type of trained behavior model.

In some implementations, the mobile sensor platform 104 can be configured to monitor one or more monitored devices 102. For example, the mobile sensor platform 104 can be configured to monitor one or more monitored devices 102 to detect an anomaly condition in the operation of the monitored device 102. In a particular aspect, one or more monitored devices 102 do not include appropriate sensors for monitoring various aspects of operation of the monitored devices. For example, a monitored device 102 can have no sensors at all (e.g., a mining drill that must operate in hazardous environments), only certain sensors that are not configured to capture appropriate information (e.g., a wind turbine that includes temperature sensors but not acoustic or vibration sensors), sensors only on a particular portion of the monitored device 102 (e.g., a sensored portion of the monitored device 102 can be damaged, disallowing communicative access to the sensors), or some combination thereof (particularly in environments in which multiple disparate monitored devices 102 are monitored by the mobile sensor platform 104).

A monitored device 102 can include a plurality of components, such as the first component 140 and the second component 142 of FIG. 1. In this context, a “component” refers to one or more devices, one or more systems, or one or more processes constituting the respective monitored device 102. To illustrate, the monitored device 102 can include one or more mechanical devices, one or more electromechanical devices, one or more electrical devices, one or more electronic devices, or various combinations thereof.

In some implementations, the computing device 110 can be configured to communicate one or more control commands 138 to the mobile sensor platform 104 and/or the monitored device 102. The control command(s) 138 can be configured to aid the mobile sensor platform 104 and/or the monitored device 102 in a variety of actions designed to avoid and/or remedy certain operational conditions or states. For example, the control command(s) 138 can be generated (e.g., by the control command generator 136) to cause the monitored device 102 to change an operational characteristic to avoid and/or remedy an anomaly condition detected by one or more trained behavior models 120.

In a particular aspect, the control command(s) 138 can be configured to instruct a component of the monitored device 102 to modify its operation. For example, the control command(s) 138 can instruct a motor for a monitored drill to reduce speed (e.g., to avoid motor failure). In another particular aspect, the control command(s) 138 can be configured to instruct the first component 140 of the monitored device 102 to modify operation of the second component 142 of the monitored device 102. For example, the control command(s) 138 can instruct a processor or controller coupled to a motor for a monitored drill, where the control command(s) 138 instruct the processor/controller to instruct the drill motor to reduce speed. In another particular aspect, the control command(s) 138 can be configured to instruct the mobile sensor platform 104 to move to a second monitored device. For example, the control command(s) 138 can be configured to instruct the mobile sensor platform 104 to cease monitoring operations associated with a first wind turbine on a remote wind farm and move to monitoring operations associated with a second wind turbine on the remote wind farm.

In still further aspects, the control command(s) 138 can be configured to instruct the mobile sensor platform 104 and/or the monitored device 102 to perform other operations pursuant to monitoring the monitored device 102 and/or take corrective action for the monitored device 102, or some combination thereof. For example, the control command(s) 138 can be configured to instruct the mobile sensor platform 104 to move to another portion of the monitored device 102 for sensing, instruct the monitored device 102 to begin shutdown operations, instruct the mobile sensor platform 104 and/or the monitored device 102 to communicate and/or store in memory particular data associated with monitoring operations for later analysis, etc.

In operation, the mobile sensor platform 104 can be configured to take one or more sensor readings associated with the operation of the monitored device 102. This can include the use of one or more sensors (e.g., the first sensor 106 and/or the second sensor 108) to monitor one or more components (e.g., the first component 140 and/or the second component 142) of an un-sensored or under-sensored device. The mobile sensor platform 104 can be further configured to transmit some or all the data associated with the sensor readings (e.g., the first sensor data 130 and/or the second sensor data 132) to the computing device 110 via the receiver 112.

Some or all the received sensor data can then be communicated (with or without preprocessing) to the one or more processors 118 of the computing device 110. The one or more processors 118 can be configured to provide, as input to one or more trained behavior models 120, input data 134 based at least in part on the received sensor data to generate the behavior model output data 122. The control command generator 136 can be configured to generate, based on the behavior model output data 122, one or more control commands 138. The computing device 110 can be configured to communicate the one or more control commands 138, via the transmitter 114, to the mobile sensor platform 104 and/or the monitored device 102. As detailed above, the control command(s) 138 can be configured to affect a variety of operations associated with monitoring the monitored device(s) 102.

In a particular aspect, one or more of the control commands 138 can be communicated to the mobile sensor platform 104 via a direct communication interface between the monitored device 102 and the mobile sensor platform 104. In other particular aspects, one or more of the control commands 138 can be communicated to the mobile sensor platform 104 via one or more direct and/or indirect communication paths, including a wired and/or wireless communication connection.

In a particular aspect, one or more of the control commands 138 can be communicated to the monitored device 102 via a direct communication interface between the computing device 110 and the monitored device 102. In other particular aspects, one or more of the control commands 138 can be communicated to the monitored device 102 via one or more direct and/or indirect communication paths, including a wired and/or wireless communication connection.

Although FIG. 1 illustrates certain components arranged in a particular manner, more, fewer, and/or different components can be present without departing from the scope of the present disclosure. For example, FIG. 1 illustrates a single mobile sensor platform 104, but a plurality of mobile sensor platforms 104 can be present within system 100. A plurality of mobile sensor platforms 104 can be deployed to monitor a single monitored device 102 and/or one or more mobile sensor platforms 104 can be deployed to monitor a plurality of monitored devices 102, where the number of mobile sensor platforms 104 deployed to monitor a particular monitored device 102 can vary. Additionally, FIG. 1 illustrates a mobile sensor platform 104 with a first sensor 106 and a second sensor 108. More or fewer sensors can be present with a particular mobile sensor platform 104 and the number, type, and/or configuration of sensors can vary between and among mobile sensor platforms 104.

Further, in a particular aspect, one or more monitored devices 102 can also include one or more sensors (e.g., acoustic, optical, infrared, etc.), one or more of which can be configured to communicate monitored device sensor data 144 to the computing device 110. In a further same or alternative particular aspect, the input data 134 to the trained behavior model(s) 120 can be based at least on a portion of the first sensor data 130 as well as a portion of the second sensor data 132, a portion of the monitored device sensor data 144, or a combination thereof.

Still further, the input data 134 can include data from a plurality of sensor types for a variety of applications. For example, one or more mobile sensor platforms 104 can be configured to generate sensor data for use in generating a sonic frequency profile (e.g., a particular set of sonic frequencies over time) associated with one or more monitored devices 102. For instance, an acoustic sensor associated with a mobile sensor platform 104 can be used to measure a sonic frequency over time for at least a first component 140 of the monitored device(s) 102. A sonic frequency profile can be generated (e.g., by the processor(s) 118 of the computing device 110 based on the acoustic sensor data. The computing device 110 can be configured to use the sonic temperature profile as a portion of the input data 134 to identify a potential risk condition associated with the monitored device(s) 102. In a particular implementation, the sonic frequency profile can be used to identify a mechanical fault associated with a pitch of a component of the monitored device(s) 102 that rotates (e.g., a wind turbine), electrical sparking associated with a component of the monitored device(s) 102 (e.g., a wire), or some combination thereof.

As an additional example, one or more mobile sensor platforms 104 can be configured to generate sensor data for use in an image profile, a humidity profile, or some combination thereof associated with one or more monitored devices 102. For instance, a camera and/or a humidity sensor associated with a mobile sensor platform 104 can be used to sense some or all of one or more monitored devices 102. An image profile and/or a humidity profile can be generated (e.g., by the processor(s) 118 of the computing device 110) based on the camera data and/or the humidity sensor data. The computing device 110 can be configured to use the image profile, humidity profile, or some combination thereof to identify potential fluid leakage associated with a component of the monitored device(s) 102 (e.g., a pipe).

As a further example, one or more mobile sensor platforms 104 can be configured to generate sensor data for use in generating a security profile associated with one or more monitored devices 102. For the purposes of this disclosure, a “security profile” can include one or more images representative of a particular security state associated with a monitored device 102. A security state can include one or more states ranging from secure to unsecure. A secure state could include, for example, a monitored device 102 with all security doors closed. An unsecure state could include, for example, a monitored device 102 with one or more security doors open. In a particular aspect, a camera associated with a mobile sensor platform 104 can be used to image some or all of one or more monitored devices 102. A security profile can be generated (e.g., by the processor(s) 118 of the computing device 110) based on the camera data. The computing device 110 can be configured to use the security profile as a portion of the input data 134 to identify a potential security risk associated with the monitored device(s) 102.

As a still further example, one or more mobile sensor platforms 104 can be configured to generate sensor data for use in generating a temperature profile (e.g., a particular set of temperatures over time), a humidity profile (e.g., a particular set of humidity measurements over time), or some combination thereof associated with one or more monitored devices 102. For instance, a temperature sensor and/or a humidity senor associated with a mobile sensor platform 104 can be used to sense some or all of one or more monitored devices 102. A temperature profile and/or a humidity profile can be generated (e.g., by the processor(s) 118) of the computing device 110) based on the temperature sensor and/or the humidity sensor, respectively. The computing device 110 can be configured to use the temperature profile and/or the humidity profile as a portion of the input data 134 to identify a potential risk condition associated with the monitored device(s) 102.

As a still further example, one or more mobile sensor platforms 104 can be configured to generate sensor data for use in generating a temperature map associated with one or more monitored devices 102. For instance, an infrared imaging sensor associated with a mobile sensor platform 104 can be used to image some or all of one or more monitored devices 102. A temperature map can be generated (e.g., by the processor(s) 118 of the computing device 110) based on the infrared imaging sensor data. The computing device 110 can be configured to use the temperature map, as a portion of the input data 134 to identify a potential risk condition associated with the monitored device(s) 102.

As a still further example, one or more mobile sensor platforms 104 can be configured to generate sensor data for use in processing images associated with one or more components of one or more monitored devices 102. For instance, a camera associated with a mobile sensor platform 104 (e.g., as the first sensor 106, the second sensor 108, etc.) can be used to capture images of one or more components of one or more monitored devices 102. The resultant images can be processed (e.g., by the processor(s) 118 of the computing device 110) to generate image data. The computing device 110 can be configured to use the image data as a portion of the input data 134 to identify one or more components of the one or more monitored devices 102, one or more safety and/or security risks associated with one or more components of the one or more monitored devices 102, etc. For example, the image data can be provided as a portion of the input data 134 to an image enhancement neural network in order to enhance the image for use in matching the image to one or more reference images of the one or more components of the one or more monitored devices 102.

Referring again to FIG. 1, in addition to the one or more sensors generating data for the input data 134, the mobile sensor platform 104 can also include the propulsion system 146 and/or the navigation system 148. In some implementations, the navigation system 148 can include an autonomous or semi-autonomous navigation system configured to navigate the mobile sensor platform 104 between or among monitored devices 102. In some aspects, the navigation system 148 can generate instruction configured to navigate the mobile sensor platform 104 via ground-, land-, and/or sea-based navigation. In the same or alternative implementations, the propulsion system 146 can include an electric-, gasoline-, diesel-, and/or battery-based propulsion system (or other suitable propulsion system) configured to propel the mobile sensor platform 104 between or among the monitored devices 102 according to instructions from the navigation system 148. In some aspects, the propulsion system 146 can include wheels, rotors, screws, turbines, tracks, or any other suitable traction system and its associated propulsion mechanism(s).

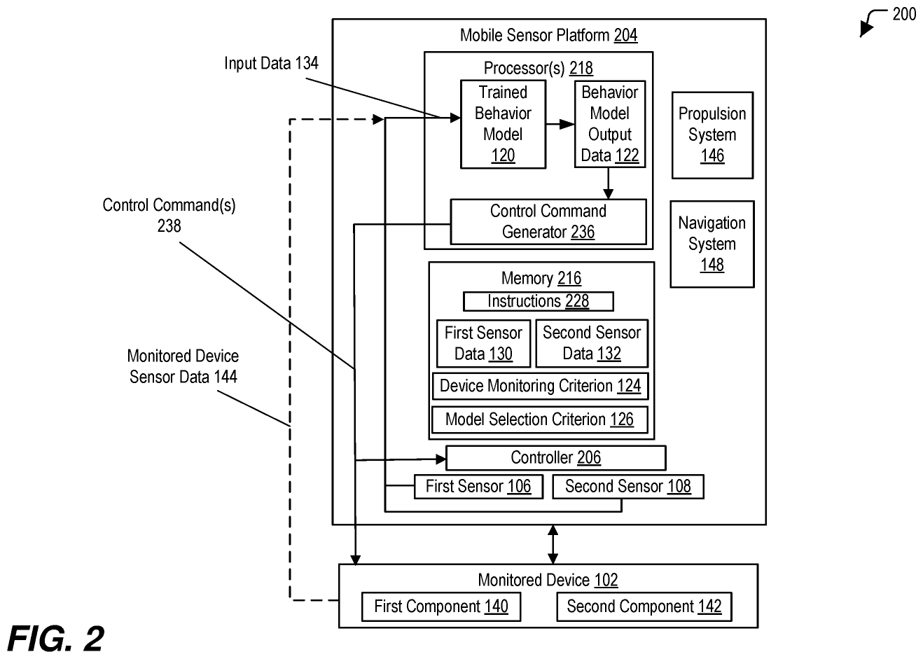

FIG. 2 depicts a system 200 for behavior monitoring of one or more monitored devices 102 using a mobile sensor platform 204 in accordance with some examples of the present disclosure. In some implementations, the mobile sensor platform 204 corresponds to, includes, or is included within the mobile sensor platform 104 of FIG. 1. In certain aspects, the mobile sensor platform 204 of FIG. 2 can perform the functions and capabilities of the computing device 110 of FIG. 1, as described in more detail above. For example, the processor(s) 218 of the mobile sensor platform 204 can be configured to receive, from a first sensor 106 of the mobile sensor platform 204, first sensor data 130 indicative of operation of the monitored device(s) 102, wherein the monitored device(s) is distinct from the mobile sensor platform 104. The processor(s) 218 can also be configured to provide, as input to one or more trained behavior models 120, input data 134 based at least in part on the first sensor data 130 to generate the behavior model output data 122. The processor(s) 218 can also be configured to generate, based on the behavior model output data 122, one or more control commands and send the control command(s) to the mobile sensor platform 104 or the monitored device(s) 102.

In the example of FIG. 2, the control command generator 236 operates similarly to the control command generator 136 of FIG. 1. The control command generator 236 can be configured to generate the control command(s) 238 for communication to a controller 206 of the mobile sensor platform 204 or the monitored device(s) 102. The controller 206 can be any microcontroller, microprocessor, or other suitable electronic, mechanical, or electromechanical device configured to control one or more components of the mobile sensor platform. For example, the controller 206 can be configured to adjust one or more of the first sensor 106 and/or the second sensor 108.

In a particular aspect, the controller 206 can be configured to activate the propulsion system 146 and or the navigation system 148 to propel the mobile sensor platform 204 to another portion of the monitored device 102 and/or to another monitored device 102. For example, the control command(s) 238 can be configured to instruct the mobile sensor platform 204 to move to another portion of the monitored device 102 for sensing, instruct the monitored device 102 to begin shutdown operations, instruct the mobile sensor platform 204 and/or the monitored device 102 to communicate and/or store in memory particular data associated with monitoring operations for later analysis, etc.

As an additional example, the control command(s) 238 can be configured to aid the mobile sensor platform 204 and/or the monitored device 102 in a variety of actions designed to avoid and/or remedy certain operational conditions or states. For example, the control command(s) 238 can be configured to instigate instructions designed to avoid and/or remedy an anomaly condition detected by one or more trained behavior models 120.

In a particular aspect, the control command(s) 238 can be configured to instruct a component of the monitored device 102 to modify its operation. For example, the control command(s) 238 can instruct a motor for a monitored drill to reduce speed (e.g., to avoid motor failure). In another particular aspect, the control command(s) 238 can be configured to instruct the first component 140 of the monitored device 102 to modify operation of the second component 142 of the monitored device 102. For example, the control command(s) 238 can instruct a processor or controller coupled to a motor for a monitored drill, where the control command(s) 238 instruct the processor/controller to instruct the drill motor to reduce speed.

In some implementations, the mobile sensor platform 204 can also include a memory 216 that is coupled to one or more processors 218. In some implementations, the memory 216 includes volatile memory devices, non-volatile memory devices, or both, such as one or more hard drives, solid-state storage devices (e.g., flash memory, magnetic memory, or phase change memory), a random access memory (RAM), a read-only memory (ROM), one or more other types of storage devices, or any combination thereof. The memory 216 stores data (e.g., one or more device monitoring criteria 224, one or more model selection criteria 226, etc.) and instructions 228 (e.g., computer code) that are executable by the one or more processors 218. For example, the instructions 228 can include one or more trained behavior models 120 (e.g., trained machine learning models) that are executable by the one or more processors 218 to initiate, perform, or control the various operations described with reference to FIG. 2. For example, the one or more trained behavior models 120 can include an anomaly detection model, an alert generation model, or both. In some implementations, the processor(s) 218 can be configured to select a trained behavior model 120 from among a plurality of trained behavior models, as described in more detail above with reference to FIG. 1.

The one or more processors 218 include one or more single-core or multi-core processing units, one or more digital signal processors (DSPs), one or more graphics processing units (GPUs), or any combination thereof. The one or more processors 218 are configured to receive a portion of the first sensor data 130 sensed by the first sensor 106 during a sensing period and/or a portion of the second sensor data 132 sensed by the second sensor 108 during the sensing period. In some implementations, the one or more processors 218 are configured to process the portion of the first sensor data 130 and/or the portion of the second sensor data 132 to generate the input data 134 for the one or more trained behavior models 120 and to use the one or more trained behavior models 120 to generate, via a control command generator 236, one or more control commands 238 for communication to other portions and/or components of the mobile sensor platform 204 or the monitored device 102. The one or more processors 218 can also be configured to process the first sensor data 130 and/or the second sensor data 132 to determine whether to generate an alert.

In operation, the mobile sensor platform 204 can be configured to perform functions similar to the combination of the mobile sensor platform 104 and the computing device 110 of FIG. 1. For example, the processor(s) 218 of the mobile sensor platform 204 can be configured to generate a sonic frequency profile for use as a portion of the input data 134 to identify a potential risk condition associated with the monitored device(s). The processor(s) 218 can also be configured to generate an image profile and/or a humidity profile for use as a portion of the input data 134 to identify potential fluid leakage associated with a component of the monitored device(s) 102. The processor(s) 218 can also be configured to generate a security profile for use as a portion of the input data 134 to identify a potential security risk associated with the monitored device(s) 102. The processor(s) 218 can also be configured to generate a temperature profile and/or a humidity profile for use as a portion of the input data 134 to identify a potential risk condition associated with the monitored device(s) 102. The processor(s) 218 can also be configured to generate a temperature map based on infrared imaging sensor data for use as a portion of the input data 134 to identify a potential risk condition associated with the monitored device(s) 102.

Although FIG. 2 illustrates certain components arranged in a particular manner, more, fewer, and/or different components can be present without departing from the scope of the present disclosure. For example, FIG. 2 illustrates a single mobile sensor platform 204, but a plurality of mobile sensor platforms 204 can be present within system 200. A plurality of mobile sensor platforms 204 can be deployed to monitor a single monitored device 102 and/or one or more mobile sensor platforms 204 can be deployed to monitor a plurality of monitored device 102, where the number of mobile sensor platforms 204 deployed to monitor a particular monitored device 102 can vary. Additionally, FIG. 2 illustrates a mobile sensor platform 204 with a first sensor 106 and a second sensor 108. More or fewer sensors can be present with a particular mobile sensor platform 204 and the number, type, and/or configuration of sensors can vary between and among mobile sensor platforms 204.

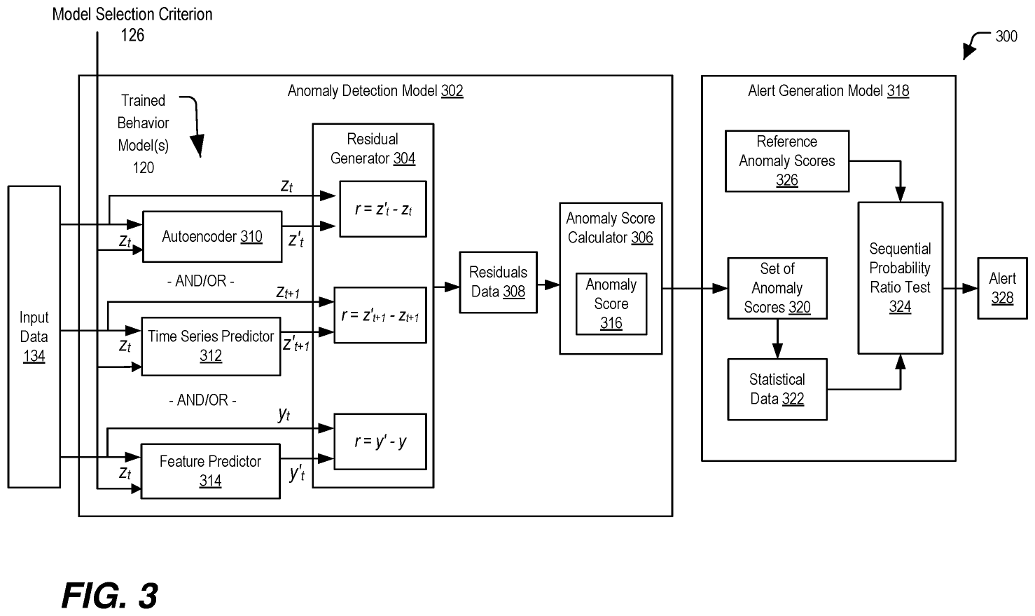

FIG. 3 depicts a block diagram of a particular implementation of components that may be included in any of the systems of FIGS. 1-2 in accordance with some examples of the present disclosure. The block diagram 300 illustrates components that can be configured to provide, as input to one or more trained behavior models 120, input data 134 to generate the alert 328.

As illustrated, the anomaly detection model 302 includes one or more trained behavior models 120, a residual generator 304, and an anomaly score calculator 306. The one or more trained behavior models 120 include an autoencoder 310, a time series predictor 312, a feature predictor 314, another behavior model, or a combination thereof. Each of the trained behavior model(s) 120 is trained to receive input data 134 (e.g., from the processor(s) 118 and/or the processor(s) 218) and to generate a model output (e.g., the behavior model output data 122 of FIGS. 1-2). The residual generator 304 is configured to compare one or more values of the model output to one or more values of the input data 134 to determine the residuals data 308.

The autoencoder 310 may include or correspond to a dimensional-reduction type autoencoder, a denoising autoencoder, or a sparse autoencoder. Additionally, in some implementations the autoencoder 310 has a symmetric architecture (e.g., an encoder portion of the autoencoder 310 and a decoder portion of the autoencoder 310 have mirror-image architectures). In other implementations, the autoencoder 310 has a non-symmetric architecture (e.g., the encoder portion has a different number, type, size, or arrangement of layers than the decoder portion).

The autoencoder 310 is trained to receive model input (denoted as zₜ), modify the model input, and reconstruct the model input to generate model output (denoted as z′ₜ). The model input includes values of one or more features of the input data 134 (e.g., raw and/or preprocessed readings from one or more sensors) for a particular timeframe (t), and the model output includes estimated values of the one or more features (e.g., the same features as the model input) for the particular timeframe (t) (e.g., the same timeframe as the model input). In a particular, non-limiting example, the autoencoder 310 is an unsupervised neural network that includes an encoder portion to compress the model input to a latent space (e.g., a layer that contains a compressed representation of the model input), and a decoder portion to reconstruct the model input from the latent space to generate the model output. The autoencoder 310 can be generated and/or trained via an automated model building process, an optimization process, or a combination thereof to reduce or minimize a reconstruction error between the model input (zₜ) and the model output (z′ₜ) when the input data 134 represents normal operation conditions associated with a monitored asset.

The time series predictor 312 may include or correspond to one or more neural networks trained to forecast future data values (such as a regression model or a generative model). The time series predictor 312 is trained to receive as model input one or more values of the input data 134 (denoted as zₜ) for a particular timeframe (t) and to estimate or predict one or more values of the input data 134 for a future timeframe (t+1) to generate model output (denoted as z′ₜ₊₁). The model input includes values of one or more features of the input data 134 (e.g., readings from one or more sensors) for the particular timeframe (t), and the model output includes estimated values of the one or more features (e.g., the same features at the model input) for a different timeframe (t+1) that the timeframe of the model input. The time series predictor 312 can be generated and/or trained via an automated model building process, an optimization process, or a combination thereof, to reduce or minimize a prediction error between the model input (zₜ) and the model output (z′ₜ₊₁) when the input data 134 represents normal operation conditions associated with a monitored asset.

The feature predictor 314 may include or correspond to one or more neural networks trained to predict data values based on other data values (such as a regression model or a generative model). The feature predictor 314 is trained to receive as model input one or more values of the input data 134 (denoted as zₜ) for a particular timeframe (t) and to estimate or predict one or more other values of the input data 134 (denoted as yₜ) to generate model output (denoted as y′ₜ). The model input includes values of one or more features of the input data 134 (e.g., readings from one or more sensors) for the particular timeframe (t), and the model output includes estimated values of the one or more other features of the input data 134 for the particular timeframe (t) (e.g., the same timeframe as the model input). The feature predictor 314 can be generated and/or trained via an automated model building process, an optimization process, or a combination thereof, to reduce or minimize a prediction error between the model input (zₜ) and the model output (y′ₜ) when the input data 134 represents normal operation conditions associated with a monitored asset.

In certain implementations, the anomaly detection model 302 can use one or more of the trained behavior models 120 according to the one or more model selection criteria 126, as described in more detail above with reference to FIG. 1. In some aspects, the anomaly detection model 302 can use one or more behavior models of one or more behavior model types (e.g., one or more autoencoders 310, one or more time series predictors 312, one or more feature predictors 314, or some combination thereof). The model selection criteria 126 can be used to identify which trained behavior model(s) 120 for use by the anomaly detection model 302.

The residual generator 304 is configured to generate a residual value (denoted as r) based on a difference between the model output of the trained behavior model(s) 120 and the input data 134. For example, when the model output is generated by an autoencoder 310, the residual can be determined according to r=z′ₜ−zₜ. As another example, when the model output is generated by a time series predictor 312, the residual can be determined according to r=z′ₜ₊₁−zₜ₊₁, where z′ₜ₊₁ is estimated based on data for a prior time step (t) and z′ₜ₊₁ is the actual value of z for a later time step (t+1). As still another example, when the model output is generated by a feature predictor 314, the residual can be determined according to r=y′ₜ−yₜ, where y′ₜ is estimated based on a value of z for a particular time step (t) and yₜ is the actual value of y for the particular time step (t). Generally, the input data 134 and the reconstruction are multivariate (e.g., a set of multiple values, with each value representing a feature of the input data 134), in which case multiple residuals are generated for each sample time frame to form the residuals data 308 for the sample time frame.

The anomaly score calculator 306 determines the anomaly score 316 for a sample time frame based on the residuals data 308. The anomaly score 316 is provided to the alert generation model 318. The alert generation model 318 evaluates the anomaly score 316 to determine whether to generate the alert 328. As one example, the alert generation model 318 compares one or more values of the anomaly score 316 to one or more respective thresholds to determine whether to generate the alert 328. The respective threshold(s) may be preconfigured or determined dynamically (e.g., based on one or more of the sensor data values, based on one or more of the input data values, or based on one or more of the anomaly score values).

In a particular implementation, the alert generation model 318 determines whether to generate the alert 328 using a sequential probability ratio test (SPRT) based on current anomaly score values and historical anomaly score values (e.g., based on historical sensor data). In FIG. 3, the alert generation model 318 accumulates a set of anomaly scores 320 representing multiple sample time frames and uses the set of anomaly scores 320 to generate statistical data 322. In the illustrated example, the alert generation model 318 uses the statistical data 322 to perform a sequential probability ratio test 324 configured to selectively generate the alert 328. For example, the sequential probability ratio test 324 is a sequential hypothesis test that provides continuous validations or refutations of the hypothesis that the monitored asset is behaving abnormally, by determining whether the anomaly score 316 continues to follow, or no longer follows, normal behavior statistics of reference anomaly scores 326. In some implementations, the reference anomaly scores 326 include data indicative of a distribution of reference anomaly scores (e.g., mean and variance) instead of, or in addition to, the actual values of the reference anomaly scores. The sequential probability ratio test 324 provides an early detection mechanism and supports tolerance specifications for false positives and false negatives.

In some implementations, the alert 328 generated by the alert generation model 318 can be communicated to a control command generator such as the control command generator 136 of FIG. 1 and/or the control command generator 236 of FIG. 2. The control command generator can be configured to generate one or more control commands (e.g., the control command(s) 138 of FIG. 1 and/or the control command(s) 238 of FIG. 2) for communication to the mobile sensor platform 104 or the monitored device 102. The control command(s) can include, for example, command(s) instructing the mobile sensor platform 104 or the monitored device 102 to take an action to remedy an error condition indicated by the alert 328.

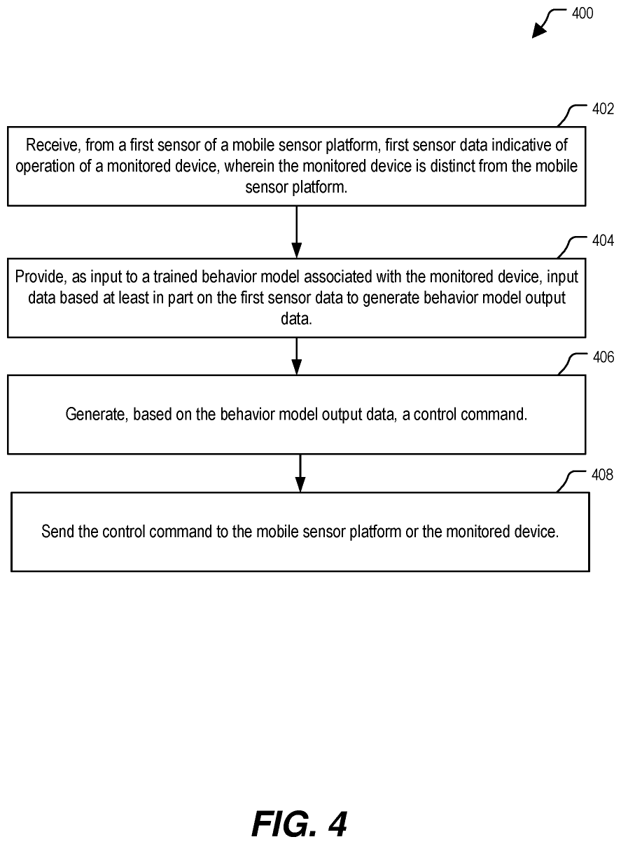

FIG. 4 is a flow chart of an example of a method 400 for behavior modeling for monitored devices using a mobile sensor platform, in accordance with some examples of the present disclosure. The method 400 may be initiated, performed, or controlled by one or more processors executing instructions, such as by the processor(s) 118 of FIG. 1 and/or the processor(s) 218 of FIG. 2 executing instructions such as the instructions 128 from the memory 116 and/or the instructions 228 from the memory 216.

In some implementations, the method 400 includes, at 402, receiving, from a first sensor of a mobile sensor platform, first sensor data indicative of operation of a monitored device, wherein the monitored device is distinct from the mobile sensor platform. For example, as described in more detail above with reference to FIGS. 1-3, the mobile sensor platform can receive a plurality of sensor data indicative of operation of a distinct monitored device.

In the example of FIG. 4, the method 400 also includes, at 404, providing, as input to a trained behavior model associated with the monitored device, input data based at least in part on the first sensor data to generate behavior model output data. For example, as described in more detail above with reference to FIGS. 1-4, a trained behavior model can help determine, among other things, whether to generate an alert based on the received sensor data.

In the example of FIG. 4, the method 400 also includes, at 406, generating based on the behavior model output data, a control command and, at 408, sending the control command to the mobile sensor platform or the monitored device. For example, as described in more detail above with reference to FIGS. 1-3, a control command can include data and/or instruction to one or more components of the mobile sensor platform and/or the monitored device in order to modify the operation of one or more components of the monitored device. In a particular aspect, modifying the operation of one or more components of the monitored device can include taking action(s) to eliminate or avoid a risk condition indicated by a detected anomaly.

Although the method 400 is illustrated as including a certain number of steps, more, fewer, and/or different steps can be included in the method 400 without departing from the scope of the present disclosure. For example, the method 400 can also include preprocessing the first sensor data prior to providing the input data and communicating the preprocessed sensor data to a processor. For example, the method 400 can include the mobile sensor platform 104 of FIG. 1 preprocessing the first sensor data 130 prior to providing the input data 134 and communicating the preprocessed first sensor data to the computing device 110.

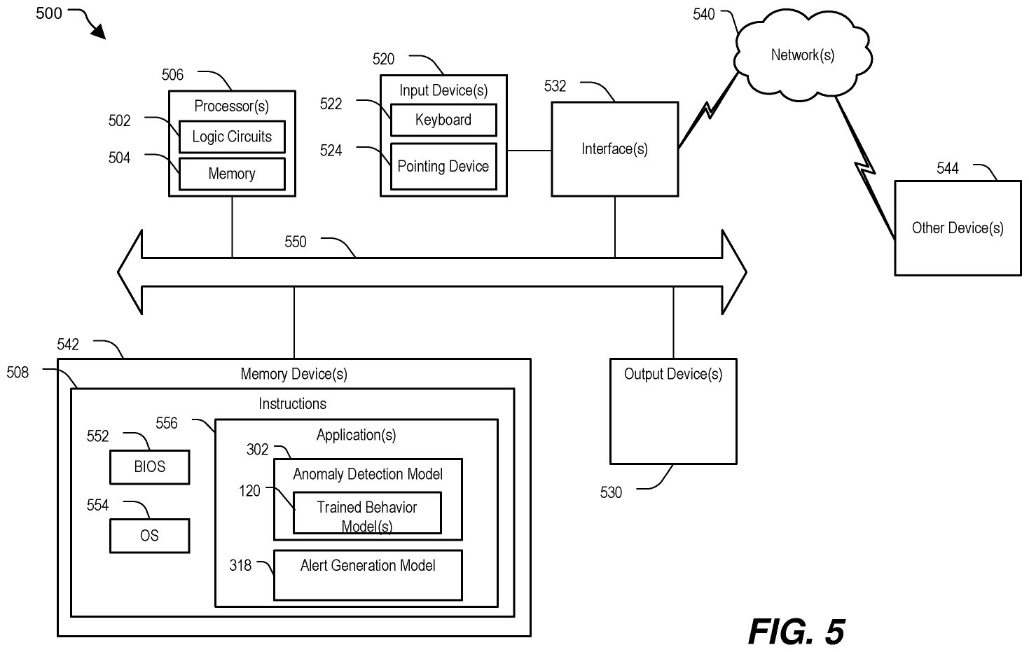

FIG. 5 illustrates an example of a computer system 500 corresponding to one or more of the systems of FIGS. 1-3. The computer system 500 can correspond to, include, or be included within the system 100 and/or the system 200, including the computing device 110 of FIG. 1, the mobile sensor platform 104, and/or the monitored device 102. For example, the computer system 500 is configured to initiate, perform, or control one or more of the operations described with reference to FIGS. 1-4. The computer system 500 can be implemented as or incorporated into one or more of various other devices, such as a personal computer (PC), a tablet PC, a server computer, a personal digital assistant (PDA), a laptop computer, a desktop computer, a communications device, a wireless telephone, or any other machine capable of executing a set of instructions (sequential or otherwise) that specify actions to be taken by that machine. Further, while a single computer system 500 is illustrated, the term “system” includes any collection of systems or sub-systems that individually or jointly execute a set, or multiple sets, of instructions to perform one or more computer functions.

While FIG. 5 illustrates one example of the computer system 500, other computer systems or computing architectures and configurations may be used for carrying out the asset monitoring operations disclosed herein. The computer system 500 includes one or more processors 506. Each processor of the one or more processors 506 can include a single processing core or multiple processing cores that operate sequentially, in parallel, or sequentially at times and in parallel at other times. Each processor of the one or more processors 506 includes circuitry defining a plurality of logic circuits 502, working memory 504 (e.g., registers and cache memory), communication circuits, etc., which together enable the processor(s) 506 to control the operations performed by the computer system 500 and enable the processor(s) 506 to generate a useful result based on analysis of particular data and execution of specific instructions.

The processor(s) 506 are configured to interact with other components or subsystems of the computer system 500 via a bus 550. The bus 550 is illustrative of any interconnection scheme serving to link the subsystems of the computer system 500, external subsystems or devices, or any combination thereof. The bus 550 includes a plurality of conductors to facilitate communication of electrical and/or electromagnetic signals between the components or subsystems of the computer system 500. Additionally, the bus 550 includes one or more bus controllers or other circuits (e.g., transmitters and receivers) that manage signaling via the plurality of conductors and that cause signals sent via the plurality of conductors to conform to particular communication protocols.

The computer system 500 also includes the one or more memory devices 542. The memory device(s) 542 include any suitable computer-readable storage device depending on, for example, whether data access needs to be bi-directional or unidirectional, speed of data access required, memory capacity required, other factors related to data access, or any combination thereof. Generally, the memory device(s) 542 includes some combinations of volatile memory devices and non-volatile memory devices, though in some implementations, only one or the other may be present. Examples of volatile memory devices and circuits include registers, caches, latches, many types of random-access memory (RAM), such as dynamic random-access memory (DRAM), etc. Examples of non-volatile memory devices and circuits include hard disks, optical disks, flash memory, and certain type of RAM, such as resistive random-access memory (ReRAM). Other examples of both volatile and non-volatile memory devices can be used as well, or in the alternative, so long as such memory devices store information in a physical, tangible medium. Thus, the memory device(s) 542 include circuits and structures and are not merely signals or other transitory phenomena (i.e., are non-transitory media).

In the example illustrated in FIG. 5, the memory device(s) 542 store the instructions 508 that are executable by the processor(s) 506 to perform various operations and functions. The instructions 508 include instructions to enable the various components and subsystems of the computer system 500 to operate, interact with one another, and interact with a user, such as an input/output system (BIOS) 552 and an operating system (OS) 554. Additionally, the instructions 508 include one or more applications 556, scripts, or other program code to enable the processor(s) 506 to perform the operations described herein.

In FIG. 5, the computer system 500 also includes one or more output devices 530, one or more input devices 520, and one or more interface devices 532. Each of the output device(s) 530, the input device(s) 520, and the interface device(s) 532 can be coupled to the bus 550 via a port or connector, such as a Universal Serial Bus port, a digital visual interface (DVI) port, a serial ATA (SATA) port, a small computer system interface (SCSI) port, a high-definition media interface (HDMI) port, or another serial or parallel port. In some implementations, one or more of the output device(s) 530, the input device(s) 520, the interface device(s) 532 is coupled to or integrated within a housing with the processor(s) 506 and the memory device(s) 542, in which case the connections to the bus 550 can be internal, such as via an expansion slot or other card-to-card connector. In other implementations, the processor(s) 506 and the memory device(s) 542 are integrated within a housing that includes one or more external ports, and one or more of the output device(s) 530, the input device(s) 520, the interface device(s) 532 is coupled to the bus 550 via the external port(s).

Examples of the output device(s) 530 include display devices, speakers, printers, televisions, projectors, or other devices to provide output of data in a manner that is perceptible by a user. Examples of the input device(s) 520 include buttons, switches, knobs, a keyboard 522, a pointing device 524, a biometric device, a microphone, a motion sensor, or another device to detect user input actions. The pointing device 524 includes, for example, one or more of a mouse, a stylus, a track ball, a pen, a touch pad, a touch screen, a tablet, another device that is useful for interacting with a graphical user interface, or any combination thereof. A particular device may be an input device 520 and an output device 530. For example, the particular device may be a touch screen.

The interface device(s) 532 are configured to enable the computer system 500 to communicate with one or more other devices 544 directly or via one or more networks 540. For example, the interface device(s) 532 may encode data in electrical and/or electromagnetic signals that are transmitted to the other device(s) 544 as control signals or packet-based communication using pre-defined communication protocols. As another example, the interface device(s) 532 may receive and decode electrical and/or electromagnetic signals that are transmitted by the other device(s) 544. To illustrate, the other device(s) 544 may include the sensor(s) 106, 108 of any of FIGS. 1-3. The electrical and/or electromagnetic signals can be transmitted wirelessly (e.g., via propagation through free space), via one or more wires, cables, optical fibers, or via a combination of wired and wireless transmission.

In an alternative embodiment, dedicated hardware implementations, such as application specific integrated circuits, programmable logic arrays and other hardware devices, can be constructed to implement one or more of the operations described herein. Accordingly, the present disclosure encompasses software, firmware, and hardware implementations.

The systems and methods illustrated herein may be described in terms of functional block components, screen shots, optional selections, and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, Java, JavaScript, VBScript, Macromedia Cold Fusion, COBOL, Microsoft Active Server Pages, assembly, PERL, PHP, AWK, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of techniques for data transmission, signaling, data processing, network control, and the like.

The systems and methods of the present disclosure may be embodied as a customization of an existing system, an add-on product, a processing apparatus executing upgraded software, a standalone system, a distributed system, a method, a data processing system, a device for data processing, and/or a computer program product. Accordingly, any portion of the system or a module or a decision model may take the form of a processing apparatus executing code, an internet based (e.g., cloud computing) embodiment, an entirely hardware embodiment, or an embodiment combining aspects of the internet, software, and hardware. Furthermore, the system may take the form of a computer program product on a computer-readable storage medium or device having computer-readable program code (e.g., instructions) embodied or stored in the storage medium or device. Any suitable computer-readable storage medium or device may be utilized, including hard disks, CD-ROM, optical storage devices, magnetic storage devices, and/or other storage media. As used herein, a “computer-readable storage medium” or “computer-readable storage device” is not a signal.

Systems and methods may be described herein with reference to block diagrams and flowchart illustrations of methods, apparatuses (e.g., systems), and computer media according to various aspects. It will be understood that each functional block of a block diagram or flowchart illustration, and combinations of functional blocks in block diagrams and flowchart illustrations, respectively, can be implemented by computer program instructions.

Computer program instructions may be loaded onto a computer or other programmable data processing apparatus to produce a machine, such that the instructions that execute on the computer or other programmable data processing apparatus create means for implementing the functions specified in the flowchart block or blocks. These computer program instructions may also be stored in a computer-readable memory or device that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

In conjunction with the described devices and techniques, an apparatus for receiving, from a first sensor of a mobile sensor platform, first sensor data indicative of operation of a monitored device includes means for receiving sensor data from one or more sensors associated with a monitored device. For example, the means for receiving can correspond to the receiver 112 of FIG. 1, the processor(s) 118 of FIG. 1, the processor(s) 218 of FIG. 2, the computing device 110 of FIG. 1, the mobile sensor platform 204 of FIG. 2, the processor(s) 506 of FIG. 5, the bus 550 of FIG. 5, one or more other circuits or devices to receive sensor data, or any combination thereof.

The apparatus also includes means for providing, as input to a trained behavior model associated with the monitored device, input data based at least in part on the first sensor data to generate behavior model output data. For example, the means for providing input data can correspond to the processor(s) 506, the bus 550, the receiver 112 of FIG. 1, the processor(s) 118 of FIG. 1, the computing device 110 of FIG. 1, the processor(s) 218 of FIG. 2, the mobile sensor platform 204 of FIG. 2, one or more other circuits or devices to provide input data to behavior models, or any combination thereof.

The apparatus also includes means for generating, based on the behavior model data, a control command. For example, the means for generating the control command based on the behavior model data can correspond to the processor(s) 506, the control command generator of FIG. 1, the processor(s) 118 of FIG. 1, the computing device 110 of FIG. 1, the control command generator 236 of FIG. 2, the processor(s) 218 of FIG. 2, the mobile sensor platform 204 of FIG. 2, one or more other circuits or devices to generate a control command, or any combination thereof.

The apparatus also includes means for sending the control command to the mobile sensor platform or the monitored device. For example, the means for sending the control command to the mobile sensor platform or the monitored device can correspond to the processor(s) 506, the bus 550, the transmitter 114 of FIG. 1, the control command generator 136 of FIG. 1, the processor(s) 118 of FIG. 1, the computing device 110 of FIG. 1, the control command generator 236 of FIG. 2, the processor(s) 218 of FIG. 2, the mobile sensor platform 204 of FIG. 2, one or more other circuits or devices to generate a control command, or any combination thereof.

Particular aspects of the disclosure are described below in the following clauses:

According to Clause 1, a method includes: receiving, from a first sensor of a mobile sensor platform, first sensor data indicative of operation of a monitored device, wherein the monitored device is distinct from the mobile sensor platform; providing, as input to a trained behavior model associated with the monitored device, input data based at least in part on the first sensor data to generate behavior model output data; generating, based on the behavior model output data, a control command; and sending the control command to the mobile sensor platform or the monitored device.

Clause 2 includes the method of Clause 1, wherein the control command instructs a component of the monitored device to modify its operation.

Clause 3 includes the method of Clause 1 or Clause 2, wherein the control command instructs a first component of the monitored device to modify operation of a second component of the monitored device.

Clause 4 includes the method of any of Clauses 1 to 3, wherein the control command instructs the mobile sensor platform to move to a second monitored device.

Clause 5 includes the method of any of Clauses 1 to 4, wherein the mobile sensor platform includes an autonomous or semi-autonomous vehicle including a propulsion system and a navigation system.

Clause 6 includes the method of Clause 5, wherein the mobile sensor platform includes an unmanned aerial vehicle.

Clause 7 includes the method of any of Clauses 1 to 6, wherein the mobile sensor platform is configured to automatically select the monitored device from among a plurality of monitored devices based on a device monitoring criterion.

Clause 8 includes the method of Clause 7, wherein the device monitoring criterion includes a temporal criterion.

Clause 9 includes the method of Clause 8, wherein the temporal criterion includes a criterion associated with a particular time of day.

Clause 10 includes the method of Clause 8 or Clause 9, wherein the temporal criterion includes a criterion associated with a particular day.

Clause 11 includes the method of any of Clauses 8 to 10, wherein the temporal criterion includes a criterion associated with a particular period of time associated with an operational schedule or a maintenance schedule for the monitored device.

Clause 12 includes the method of any of Clauses 8 to 11, wherein the temporal criterion includes a criterion identifying a particular sensing time period.

Clause 13 includes the method of Clause 7, wherein the device monitoring criterion includes a sensor data criterion.

Clause 14 includes the method of Clause 13, wherein the sensor data criterion identifies a measurement made by one or more sensors of the mobile sensor platform.

Clause 15 includes the method of Clause 14, wherein the measurement is a measurement of a second monitored device.

Clause 16 includes the method of any of Clauses 1 to 15, wherein the first sensor includes an acoustic sensor.

Clause 17 includes the method of any of Clauses 1 to 16, wherein the first sensor includes an optical sensor.

Clause 18 includes the method of any of Clauses 1 to 17, wherein the first sensor includes an infrared sensor.

Clause 19 includes the method of any of Clauses 1 to 18, wherein the first sensor includes a vibration sensor.

Clause 20 includes the method of any of Clauses 1 to 19, wherein the first sensor includes a tachometer.

Clause 21 includes the method of any of Clauses 1 to 20, wherein the input data includes data representative of a sound generated by operation of the monitored device.

Clause 22 includes the method of any of Clauses 1 to 21, wherein the input data includes data associated with an optical measurement of the monitored device.

Clause 23 includes the method of any of Clauses 1 to 22, wherein the input data includes data associated with a vibration measurement of the monitored device.

Clause 24 includes the method of any of Clauses 1 to 23, wherein the input data includes data associated with a rotational measurement of the monitored device.

Clause 25 includes the method of any of Clauses 1 to 24, further including receiving, from a second sensor, second sensor data indicative of operation of the monitored device.

Clause 26 includes the method of Clause 25, wherein the input data is based at least in part on the second sensor data to generate behavior model output data.

Clause 27 includes the method of any of Clauses 1 to 26, wherein the method further includes selecting the trained behavior model from among a plurality of trained behavior models, wherein each of the plurality of trained behavior models is associated with one or more monitored devices.

Clause 28 includes the method of Clause 27, wherein selecting the trained behavior model includes selecting the trained behavior model based on a model selection criterion, the model selection criterion associated with a location of the mobile sensor platform.

Clause 29 includes the method of Clause 27 or Clause 28, wherein selecting the trained behavior model includes selecting the trained behavior model based on a model selection criterion, the model selection criterion associated with a device type of the monitored device.

Clause 30 includes the method of any of Clauses 27 to 29, wherein selecting the trained behavior model includes selecting the trained behavior model based on a model selection criterion, the model selection criterion associated with a maintenance history of the monitored device.

Clause 31 includes the method of any of Clauses 1 to 30, wherein a processor of the mobile sensor platform is configured to generate the control command and send the control command to a controller of the mobile sensor platform.

Clause 32 includes the method of any of Clauses 1 to 31, wherein the monitored device is configured to generate monitored device sensor data.

Clause 33 includes the method of any of Clauses 1 to 32, wherein the mobile sensor platform is configured to provide the input data as input to the trained behavior model.

Clause 34 includes the method of Clause 32, wherein the input data is based at least on the monitored device sensor data.

Clause 35 includes the method of any of Clauses 1 to 34, wherein the mobile sensor platform is configured to generate the behavior model output data.

Clause 36 includes the method of any of Clauses 1 to 35, wherein the monitored device is configured to generate the behavior model output data.

Clause 37 includes the method of any of Clauses 1 to 36, wherein the trained behavior model includes an autoencoder.

Clause 38 includes the method any of Clauses 1 to 37, wherein the trained behavior model includes an operational state classifier.

Clause 39 includes the method of any of Clauses 1 to 38, wherein the behavior model output data includes an anomaly score.

Clause 40 includes the method of Clause 39, wherein the method further includes determining whether to generate an alert based on the anomaly score.

Clause 41 includes the method of any of Clauses 1 to 40, wherein the method further includes, prior to providing the input data, preprocessing the first sensor data at the mobile sensor platform.

Clause 42 includes the method of Clause 41, wherein preprocessing the first sensor data includes a batch normalization process.

Clause 43 includes the method of Clause 41 or Clause 42, wherein preprocessing the first sensor data includes a resampling process.

Clause 44 includes the method of any of Clauses 1 to 43, wherein the control command is generated by a computing device, wherein the computing device is distinct from the mobile sensor platform and the monitored device.

Clause 45 includes the method of any of Clauses 1 to 44, wherein the input data is provided as input to the trained behavior model by a computing device, wherein the computing device is distinct from the mobile sensor platform and the monitored device.

Clause 46 includes the method of Clause 45, wherein the method further includes, prior to providing the input data, preprocessing the first sensor data at the mobile sensor platform; and communicating the preprocessed first sensor data to the computing device.

Clause 47 includes the method of any of Clauses 1 to 46, wherein the behavior model output data is generated by a computing device, wherein the computing device is distinct from the mobile sensor platform and the monitored device.

Clause 48 includes the method of Clause 47, wherein the method further includes, prior to providing the input data, preprocessing the first sensor data at the mobile sensor platform; and communicating the preprocessed first sensor data to the computing device.

Clause 49 includes the method of any of Clauses 1 to 48, wherein the first sensor data is received by the monitored device via a direct communication interface between the monitored device and the mobile sensor platform.

Clause 50 includes the method of any of Clauses 1 to 49, wherein the first sensor data is received by a computing device via a direct communication interface between a computing device and the mobile sensor platform, wherein the computing device is distinct from the mobile sensor platform and the monitored device.

Clause 51 includes the method of any of Clauses 1 to 50, wherein the control command is sent to the mobile sensor platform via a direct communication interface between the monitored device and the mobile sensor platform.

Clause 52 includes the method of any of Clauses 1 to 51, wherein the control command is sent to the mobile sensor platform via a direct communication interface between a computing device and the mobile sensor platform, wherein the computing device is distinct from the mobile sensor platform and the monitored device.

According to Clause 53, a system includes: one or more processors configured to: receive, from a first sensor of a mobile sensor platform, first sensor data indicative of operation of a monitored device, wherein the monitored device is distinct from the mobile sensor platform; provide, as input to a trained behavior model associated with the monitored device, input data based at least in part on the first sensor data to generate behavior model output data; generate, based on the behavior model output data, a control command; and send the control command to the mobile sensor platform or the monitored device.

Clause 54 includes the system of Clause 53, wherein the control command instructs a component of the monitored device to modify its operation.

Clause 55 includes the system of Clause 53 or Clause 54, wherein the control command instructs a first component of the monitored device to modify operation of a second component of the monitored device.

Clause 56 includes the system of any of Clauses 53 to 55, wherein the control command instructs the mobile sensor platform to move to a second monitored device.

Clause 57 includes the system of any of Clauses 53 to 56, wherein the mobile sensor platform includes an autonomous or semi-autonomous vehicle including a propulsion system and a navigation system.

Clause 58 includes the system of Clause 57, wherein the mobile sensor platform includes an unmanned aerial vehicle.

Clause 59 includes the system of Clause 57 or Clause 58, wherein the mobile sensor platform is configured to automatically select the monitored device from among a plurality of monitored devices based on a device monitoring criterion.

Clause 60 includes the system of Clause 59, wherein the device monitoring criterion includes a temporal criterion.

Clause 61 includes the system of Clause 60, wherein the temporal criterion includes a criterion associated with a particular time of day.

Clause 62 includes the system of Clause 60 or 61, wherein the temporal criterion includes a criterion associated with a particular day.

Clause 63 includes the system of any of Clauses 60-62, wherein the temporal criterion includes a criterion associated with a particular period of time associated with an operational schedule or a maintenance schedule for the monitored device.

Clause 64 includes the system of any of Clauses 60-63, wherein the temporal criterion includes a criterion identifying a particular sensing time period.

Clause 65 includes the system of Clause 59, wherein the device monitoring criterion includes a sensor data criterion.

Clause 66 includes the system of Clause 65, wherein the sensor data criterion identifies a measurement made by one or more sensors of the mobile sensor platform.

Clause 67 includes the system of Clause 66, wherein the measurement is a measurement of a second monitored device.

Clause 68 includes the system of any of Clauses 53 to 67, wherein the first sensor includes an acoustic sensor.

Clause 69 includes the system of any of Clauses 53 to 68, wherein the first sensor includes an optical sensor.

Clause 70 includes the system of any of Clauses 53 to 69, wherein the first sensor includes an infrared sensor.

Clause 71 includes the system of any of Clauses 53 to 70, wherein the first sensor includes a vibration sensor.

Clause 72 includes the system of any of Clauses 53 to 71, wherein the first sensor includes a tachometer.

Clause 73 includes the system of any of Clauses 53 to 72, wherein the input data includes data representative of a sound generated by operation of the monitored device.

Clause 74 includes the method of any of Clauses 53 to 73, wherein the input data includes data associated with an optical measurement of the monitored device.

Clause 75 includes the system of any of Clauses 53 to 74, wherein the input data includes data associated with a vibration measurement of the monitored device.

Clause 76 includes the system of any of Clauses 53 to 75, wherein the input data includes data associated with a rotational measurement of the monitored device.

Clause 77 includes the system of any of Clauses 53 to 76, wherein the one or more processors are further configured to receive, from a second sensor, second sensor data indicative of operation of the monitored device.

Clause 78 includes the system of Clause 77, wherein the input data is based at least in part on the second sensor data to generate behavior model output data.

Clause 79 includes the system of any of Clauses 53 to 78, wherein the one or more processors are further configured to select the trained behavior model from among a plurality of trained behavior models, wherein each of the plurality of trained behavior models is associated with one or more monitored devices.

Clause 80 includes the system of Clause 79, wherein the one or more processors are configured to select the trained behavior model by selecting the trained behavior model based on a model selection criterion, the model selection criterion associated with a location of the mobile sensor platform.

Clause 81 includes the system of Clause 79 or Clause 80, wherein the one or more processors are configured to select the trained behavior model by selecting the trained behavior model based on a model selection criterion, the model selection criterion associated with a device type of the monitored device.

Clause 82 includes the system of any of Clauses 79 to 81, wherein the one or more processors are configured to select the trained behavior model by selecting the trained behavior model based on a model selection criterion, the model selection criterion associated with a maintenance history of the monitored device.

Clause 83 includes the system of any of Clauses 53 to 82, wherein a processor of the mobile sensor platform is configured to generate the control command and send the control command to a controller of the mobile sensor platform.

Clause 84 includes the system of any of Clauses 53 to 83, wherein the monitored device is configured to generate monitored device sensor data.

Clause 85 includes the system of any of Clauses 53 to 84, wherein the mobile sensor platform is configured to provide the input data as input to the trained behavior model.

Clause 86 includes the system of Clause 84, wherein the input data is based at least on the monitored device sensor data.

Clause 87 includes the system of any of Clauses 53 to 86, wherein the mobile sensor platform is configured to generate the behavior model output data.

Clause 88 includes the system of any of Clauses 53 to 87, wherein the monitored device is configured to generate the behavior model output data.

Clause 89 includes the system of any of Clauses 53 to 88, wherein the trained behavior model includes an autoencoder.

Clause 90 includes the system of any of Clauses 53 to 89, wherein the trained behavior model includes an operational state classifier.

Clause 91 includes the system of any of Clauses 53 to 90, wherein the behavior model output data includes an anomaly score.

Clause 92 includes the system of Clause 91, wherein the one or more processors are further configured to determine whether to generate an alert based on the anomaly score.

Clause 93 includes the system of any of Clauses 53 to 92, wherein the mobile sensor platform is configured to preprocess the first sensor data prior to the processors providing the input data.

Clause 94 includes the system of Clause 93, wherein preprocessing the first sensor data includes a batch normalization process.

Clause 95 includes the system of Clause 93 or Clause 94, wherein preprocessing the first sensor data includes a resampling process.

Clause 96 includes the system of any of Clauses 53 to 82 and 84 to 95, wherein the control command is generated at a computing device, wherein the computing device is distinct from the mobile sensor platform and the monitored device.

Clause 97 includes the system of any of Clauses 53 to 82 and 84 to 96, wherein the input data is provided as input to the trained behavior model at a computing device, wherein the computing device is distinct from the mobile sensor platform and the monitored device.

Clause 98 includes the system of Clause 97, wherein the mobile sensor platform is configured to preprocess the first sensor data prior to providing the input data. The mobile sensor platform is also configured to communicate the preprocessed first sensor data to the computing device.

Clause 99 includes the system of any of Clauses 97 to 98, wherein the behavior model output data is generated at a computing device, wherein the computing device is distinct from the mobile sensor platform and the monitored device.

Clause 100 includes the system of Clause 99, wherein the mobile sensor platform is configured to preprocess the first sensor data prior to providing the input data. The mobile sensor platform is also configured to communicate the preprocessed first sensor data to the computing device.

Clause 101 includes the system of any of Clauses 53 to 100, wherein the first sensor data is received by the monitored device via a direct communication interface between the monitored device and the mobile sensor platform.

Clause 102 includes the system of any of Clauses 53 to 101, wherein the first sensor data is received by a computing device via a direct communication interface between a computing device and the mobile sensor platform, wherein the computing device is distinct from the mobile sensor platform and the monitored device.

Clause 103 includes the system of any of Clauses 53 to 102, wherein the control command is sent to the mobile sensor platform via a direct communication interface between the monitored device and the mobile sensor platform.

Clause 104 includes the system of any of Clauses 53 to 103, wherein the control command is sent to the mobile sensor platform via a direct communication interface between a computing device and the mobile sensor platform, wherein the computing device is distinct from the mobile sensor platform and the monitored device.

According to Clause 105 a computer-readable storage device stores instructions that, when executed by one or more processors, cause the one or more processors to: receive, from a first sensor of a mobile sensor platform, first sensor data indicative of operation of a monitored device, wherein the monitored device is distinct from the mobile sensor platform; provide, as input to a trained behavior model associated with the monitored device, input data based at least in part on the first sensor data to generate behavior model output data; generate, based on the behavior model output data, a control command; and send the control command to the mobile sensor platform or the monitored device.

Clause 106 includes the computer-readable storage device of Clause 105, wherein the control command instructs a component of the monitored device to modify its operation.

Clause 107 includes the computer-readable storage device of Clause 105 or Clause 106, wherein the control command instructs a first component of the monitored device to modify operation of a second component of the monitored device.

Clause 108 includes the computer-readable storage device of any of Clauses 105 to 107, wherein the control command instructs the mobile sensor platform to move to a second monitored device.

Clause 109 includes the computer-readable storage device of any of Clauses 105 to 108, wherein the mobile sensor platform includes an autonomous or semi-autonomous vehicle including a propulsion system and a navigation system.

Clause 110 includes the computer-readable storage device of Clause 109, wherein the mobile sensor platform includes an unmanned aerial vehicle.

Clause 111 includes the computer-readable storage device of Clause 109 or Clause 110, wherein the mobile sensor platform is configured to automatically select the monitored device from among a plurality of monitored devices based on a device monitoring criterion.

Clause 112 includes the computer-readable storage device of Clause 111, wherein the device monitoring criterion includes a temporal criterion.

Clause 113 includes the computer-readable storage device of Clause 112, wherein the temporal criterion includes a criterion associated with a particular time of day.

Clause 114 includes the computer-readable storage device of Clause 112 or Clause 113, wherein the temporal criterion includes a criterion associated with a particular day.

Clause 115 includes the computer-readable storage device of any of Clauses 112 to 114, wherein the temporal criterion includes a criterion associated with a particular period of time associated with an operational schedule or a maintenance schedule for the monitored device.

Clause 116 includes the computer-readable storage device of any of Clauses 112 to 115, wherein the temporal criterion includes a criterion identifying a particular sensing time period.

Clause 117 includes the computer-readable storage device of Clause 116, wherein the device monitoring criterion includes a sensor data criterion.

Clause 118 includes the computer-readable storage device of Clause 117, wherein the sensor data criterion identifies a measurement made by one or more sensors of the mobile sensor platform.

Clause 119 includes the computer-readable storage device of Clause 118, wherein the measurement is a measurement of a second monitored device.

Clause 120 includes the computer-readable storage device of any of Clauses 105 to 119, wherein the first sensor includes an acoustic sensor.

Clause 121 includes the computer-readable storage device of any of Clauses 105 to 120, wherein the first sensor includes an optical sensor.

Clause 122 includes the computer-readable storage device of any of Clauses 105 to 121, wherein the first sensor includes an infrared sensor.

Clause 123 includes the computer-readable storage device of any of Clauses 105 to 122, wherein the first sensor includes a vibration sensor.

Clause 124 includes the computer-readable storage device of any of Clauses 105 to 123, wherein the first sensor includes a tachometer.

Clause 125 includes the computer-readable storage device of any of Clauses 105 to 124, wherein the input data includes data representative of a sound generated by operation of the monitored device.

Clause 126 includes the method of any of Clauses 105 to 125, wherein the input data includes data associated with an optical measurement of the monitored device.

Clause 127 includes the computer-readable storage device of any of Clauses 105 to 126, wherein the input data includes data associated with a vibration measurement of the monitored device.

Clause 128 includes the computer-readable storage device of any of Clauses 105 to 127, wherein the input data includes data associated with a rotational measurement of the monitored device.

Clause 129 includes the computer-readable storage device of any of Clauses 105 to 128, wherein the one or more processors are further configured to receive, from a second sensor, second sensor data indicative of operation of the monitored device.

Clause 130 includes the computer-readable storage device of Clause 129, wherein the input data is based at least in part on the second sensor data to generate behavior model output data.

Clause 131 includes the computer-readable storage device of any of Clauses 105 to 130, wherein the one or more processors are further configured to select the trained behavior model from among a plurality of trained behavior models, wherein each of the plurality of trained behavior models is associated with one or more monitored devices.

Clause 132 includes the computer-readable storage device of Clause 131, wherein the one or more processors are configured to select the trained behavior model by selecting the trained behavior model based on a model selection criterion, the model selection criterion associated with a location of the mobile sensor platform.

Clause 133 includes the computer-readable storage device of Clause 131 or Clause 132, wherein the processor configured to select the trained behavior model by selecting the trained behavior model based on a model selection criterion, the model selection criterion associated with a device type of the monitored device.

Clause 134 includes the computer-readable storage device of any of Clauses 131 to 133, wherein the one or more processors are configured to select the trained behavior model by selecting the trained behavior model based on a model selection criterion, the model selection criterion associated with a maintenance history of the monitored device.

Clause 135 includes the computer-readable storage device of any of Clauses 105 to 134, wherein a processor of the mobile sensor platform is configured to generate the control command and send the control command to a controller of the mobile sensor platform.

Clause 136 includes the computer-readable storage device of any of Clauses 105 to 135, wherein the monitored device is configured to generate monitored device sensor data.

Clause 137 includes the computer-readable storage device of any of Clauses 105 to 136, wherein the mobile sensor platform is configured to provide the input data as input to the trained behavior model.

Clause 138 includes the computer-readable storage device of Clause 136, wherein the input data is based at least on the monitored device sensor data.

Clause 139 includes the computer-readable storage device of any of Clauses 105 to 138, wherein the mobile sensor platform is configured to generate the behavior model output data.

Clause 140 includes the computer-readable storage device of any of Clauses 105 to 139, wherein the monitored device is configured to generate the behavior model output data.

Clause 141 includes the computer-readable storage device of any of Clauses 105 to 140, wherein the trained behavior model includes an autoencoder.

Clause 142 includes the computer-readable storage device of any of Clauses 105 to 141, wherein the trained behavior model includes an operational state classifier.

Clause 143 includes the computer-readable storage device of any of Clauses 105 to 142, wherein the behavior model output data includes an anomaly score.

Clause 144 includes the computer-readable storage device of Clause 143, wherein the processors is further configured to determine whether to generate an alert based on the anomaly score.

Clause 145 includes the computer-readable storage device of any of Clauses 105 to 144, wherein processor is further configured to, prior to providing the input data, preprocess the first sensor data at the mobile sensor platform.

Clause 146 includes the computer-readable storage device of Clause 145, wherein preprocessing the first sensor data includes a batch normalization process.

Clause 147 includes the computer-readable storage device of Clause 145 or Clause 146, wherein preprocessing the first sensor data includes a resampling process.

Clause 148 includes the computer-readable storage device of any of Clauses 105 to 134 and 136 to 147, wherein the control command is generated by a computing device, wherein the computing device is distinct from the mobile sensor platform and the monitored device.

Clause 149 includes the computer-readable storage device of any of Clauses 105 to 134 and 136 to 148, wherein the input data is provided as input to the trained behavior model at a computing device, wherein the computing device is distinct from the mobile sensor platform and the monitored device.

Clause 150 includes the computer-readable storage device of Clause 149, wherein the mobile sensor platform is configured to preprocess the first sensor data prior to providing the input data. The mobile sensor platform is also configured to communicate the preprocessed first sensor data to the computing device.

Clause 151 includes the computer-readable storage device of any of Clauses 149 to 150, wherein the behavior model output data is generated at a computing device, wherein the computing device is distinct from the mobile sensor platform and the monitored device.

Clause 152 includes the computer-readable storage device of Clause 151, wherein the mobile sensor platform is configured to preprocess the first sensor data prior to providing the input data. The mobile sensor platform is also configured to communicate the preprocessed first sensor data to the computing device.

Clause 153 includes the computer-readable storage device of any of Clauses 105 to 152, wherein the first sensor data is received by the monitored device via a direct communication interface between the monitored device and the mobile sensor platform.

Clause 154 includes the computer-readable storage device of any of Clauses 105 to 153, wherein the first sensor data is received by a computing device via a direct communication interface between a computing device and the mobile sensor platform, wherein the computing device is distinct from the mobile sensor platform and the monitored device.

Clause 155 includes the computer-readable storage device of any of Clauses 105 to 154, wherein the control command is sent to the mobile sensor platform via a direct communication interface between the monitored device and the mobile sensor platform.

Clause 156 includes the computer-readable storage device of any of Clauses 105 to 155, wherein the control command is sent to the mobile sensor platform via a direct communication interface between a computing device and the mobile sensor platform, wherein the computing device is distinct from the mobile sensor platform and the monitored device.

Although the disclosure may include one or more methods, it is contemplated that it may be embodied as computer program instructions on a tangible computer-readable medium, such as a magnetic or optical memory or a magnetic or optical disk/disc. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Changes and modifications may be made to the disclosed embodiments without departing from the scope of the present disclosure. These and other changes or modifications are intended to be included within the scope of the present disclosure, as expressed in the following claims.

What is claimed is:

1. A method comprising:
receiving, from a first sensor of a mobile sensor platform, first sensor data indicative of operation of a monitored device, wherein the monitored device is distinct from the mobile sensor platform;
providing, as input to a trained behavior model associated with the monitored device, input data based at least in part on the first sensor data to generate behavior model output data;
generating, based on the behavior model output data, a control command; and
sending the control command to the mobile sensor platform or the monitored device.

2. The method of claim 1, further comprising selecting the trained behavior model from among a plurality of trained behavior models, wherein each of the plurality of trained behavior models is associated with one or more monitored devices.

3. The method of claim 2, wherein selecting the trained behavior model comprises selecting the trained behavior model based on a model selection criterion, the model selection criterion associated with a location of the mobile sensor platform.

4. The method of claim 2, wherein selecting the trained behavior model comprises selecting the trained behavior model based on a model selection criterion, the model selection criterion associated with a device type of the monitored device.

5. The method of claim 2, wherein selecting the trained behavior model comprises selecting the trained behavior model based on a model selection criterion, the model selection criterion associated with a maintenance history of the monitored device.

6. The method of claim 1, wherein the input data is provided as input to the trained behavior model by a computing device, wherein the computing device is distinct from the mobile sensor platform and the monitored device.

7. The method of claim 6, further comprising:
prior to providing the input data, preprocessing the first sensor data at the mobile sensor platform; and
communicating the preprocessed first sensor data to the computing device.

8. The method of claim 1, wherein the behavior model output data is generated by a computing device, wherein the computing device is distinct from the mobile sensor platform and the monitored device.

9. The method of claim 8, further comprising:
prior to providing the input data, preprocessing the first sensor data at the mobile sensor platform; and
communicating the preprocessed first sensor data to the computing device.

10. The method of claim 1, wherein the mobile sensor platform comprises an autonomous or semi-autonomous vehicle comprising a propulsion system and a navigation system.

11. The method of claim 10, wherein the mobile sensor platform comprises an unmanned aerial vehicle.

12. The method of claim 10, wherein the mobile sensor platform is configured to automatically select the monitored device from among a plurality of monitored devices based on a device monitoring criterion.

13. The method of claim 12, wherein the device monitoring criterion comprises a temporal criterion.

14. The method of claim 13, wherein the temporal criterion comprises a criterion associated with a particular time of day.

15. The method of claim 14, wherein the temporal criterion comprises a criterion associated with a particular day.

16. The method of claim 14, wherein the temporal criterion comprises a criterion associated with a particular period of time associated with an operational schedule or a maintenance schedule for the monitored device.

17. The method of claim 14, wherein the temporal criterion comprises a criterion identifying a particular sensing time period.

18. A system for behavior monitoring, the system comprising:
one or more processors configured to:
receive, from a first sensor of a mobile sensor platform, first sensor data indicative of operation of a monitored device, wherein the monitored device is distinct from the mobile sensor platform;
provide, as input to a trained behavior model associated with the monitored device, input data based at least in part on the first sensor data to generate behavior model output data;
generate, based on the behavior model output data, a control command; and
send the control command to the mobile sensor platform or the monitored device.

19. The system of claim 18, wherein the control command instructs a first component of the monitored device to modify operation of a second component of the monitored device.

20. A computer-readable storage device storing instructions that, when executed by one or more processors, cause the one or more processors to:
receive, from a first sensor of a mobile sensor platform, first sensor data indicative of operation of a monitored device, wherein the monitored device is distinct from the mobile sensor platform;
provide, as input to a trained behavior model associated with the monitored device, input data based at least in part on the first sensor data to generate behavior model output data;
generate, based on the behavior model output data, a control command; and
send the control command to the mobile sensor platform or the monitored device.
